(19) United States
(12) Patent Application Publication
(10) Pub. No.: US 2026/0256556 A1
(43) Pub. Date: Sep. 3, 2026

(54) SPARSE NEAR INFRARED IMAGING

(71) Applicant: Align Technology, Inc., San Jose, CA (US)

(72) Inventor: Ofer Saphier, Petach Tikva (IL)

(21) Appl. No.: 19/468,967

(22) Filed: Feb. 3, 2026

Related U.S. Application Data
(60) Provisional application No. 63/755,095, filed on Feb. 6, 2025.

(51) Int. Cl. A61C 9/00; G01J 5/00; G01J 5/08

(52) U.S. Cl. CPC A61C 9/0053; G01J 5/0859; G01J 2005/0077

(57) ABSTRACT

A method of intraoral scanning uses patterned infrared light. The method includes projecting patterned infrared light onto a tooth, and generating one or more images of the patterned infrared light projected onto the tooth. The method further includes determining one or more internal properties of the tooth based on the one or more images. An intraoral scanning system is configured to perform the method of intraoral scanning.

### RELATED APPLICATIONS

This patent application claims the benefit under 35 U.S.C. § 119(e) of U.S. Provisional Application No. 63/755,095, filed Feb. 6, 2025, which is incorporated by reference herein.

### TECHNICAL FIELD

Embodiments of the present disclosure relate to the field of intraoral scanning and, in particular, to a system and method for using infrared or near infrared (NIR) structured light projection to determine information about the internal structure of teeth.

### BACKGROUND

Intraoral scanners gather three-dimensional (3D) information about the outer surface of scanned oral structured (e.g., teeth, gingiva, etc. on the upper and/or lower dental arches) of a patient. Some state-of-the-art intraoral scanners use NIR light to generate 2D images of an internal structure of the teeth of the patient. Such NIR light provides a smooth, un-patterned illumination. Notably, while intraoral scanners generate 3D information about the external surfaces of teeth, the near-infrared imaging used to gather information about the internal structure of the teeth is 2D information. Additionally, the 2D information about the internal structure of the teeth may have a limited accuracy.

### SUMMARY

In a first aspect of the disclosure, a method comprises projecting patterned infrared light comprising a plurality of infrared light rays onto a tooth using a structured light projector of an intraoral scanner; generating one or more images of the patterned infrared light projected onto the tooth by one or more cameras of the intraoral scanner; identifying, in the one or more images, a surface reflection of the plurality of infrared light rays with a surface of the tooth; identifying, in the one or more images, scattering of the plurality of infrared light rays associated with an internal structure of the tooth; and determining one or more properties of the tooth based on at least one of the surface reflection or the scattering.

### BRIEF DESCRIPTION OF THE DRAWINGS

The present disclosure is illustrated by way of example, and not by way of limitation, in the figures of the accompanying drawings.

FIG. 1A illustrates an intraoral scanner imaging an internal structure of a tooth using a projected infrared light pattern, in accordance with embodiments of the present disclosure.

FIG. 1B illustrates an intraoral scanner imaging an internal structure of a tooth having a caries using an infrared structured light pattern, in accordance with embodiments of the present disclosure.

FIG. 1C illustrates an intraoral scanner imaging an internal structure of a tooth having a crack using an infrared structured light pattern, in accordance with embodiments of the present disclosure.

FIG. 2A illustrates a flow diagram for a method of imaging an internal structure of a tooth based on projecting patterned infrared light, in accordance with embodiments of the present disclosure.

FIG. 2B illustrates a flow diagram for a method of determining a depth of an internal structure of a tooth, in accordance with embodiments of the present disclosure.

FIG. 2C illustrates a flow diagram for a method of determining an internal structure of a tooth based on projecting patterned infrared light and projecting patterned visible light, in accordance with embodiments of the present disclosure.

FIG. 3A illustrates examples of infrared light rays travelling through a tooth, in accordance with embodiments of the present disclosure.

FIG. 3B illustrates further examples of infrared light rays travelling through a tooth, in accordance with embodiments of the present disclosure.

FIG. 3C illustrates an infrared laser and camera of an intraoral scanner positioned relative to a scanned tooth, in accordance with embodiments of the present disclosure.

FIG. 3D illustrates effects of polarization on detection of infrared light rays projected through a tooth, in accordance with embodiments of the present disclosure.

FIG. 3E illustrates an infrared laser and camera of an intraoral scanner positioned relative to a scanned tooth, in accordance with embodiments of the present disclosure.

FIG. 3F illustrates further effects of polarization on detection of infrared light rays projected through a tooth, in accordance with embodiments of the present disclosure.

FIG. 4 illustrates one embodiment of a system for performing intraoral scanning and generating a virtual 3D model of a dental arch.

FIG. 5 is a schematic illustration of a wand (e.g., intraoral scanner) with a plurality of structured light projectors and cameras disposed within a probe at a distal end of the wand, in accordance with embodiments of the present disclosure.

FIG. 6 is a chart depicting a plurality of different configurations for the position of the structured light projectors and the cameras in the probe of FIG. 5, in accordance with embodiments of the present disclosure.

FIG. 7 is a schematic illustration of a structured light projector projecting a distribution of discrete unconnected spots of light onto a plurality of object focal planes, in accordance with embodiments of the present disclosure.

FIGS. 8A-B are schematic illustrations of a structured light projector projecting discrete unconnected spots and a camera sensor detecting spots, in accordance with embodiments of the present disclosure.

FIG. 9 is a flow chart outlining a method for determining depth values of points in an intraoral scan, in accordance with embodiments of the present disclosure.

FIG. 10 is a flowchart outlining a method for carrying out a specific operation in the method of FIG. 9, in accordance with embodiments of the present disclosure.

FIGS. 11, 12, 13, and 14 are schematic illustrations depicting a simplified example of the operations of FIG. 10, in accordance with embodiments of the present disclosure.

FIG. 15 is a flow chart outlining further operations in the method for generating a digital three-dimensional image, in accordance with embodiments of the present disclosure.

FIGS. 16, 17, 18, and 19 are schematic illustrations depicting a simplified example of the operations of FIG. 15, in accordance with embodiments of the present disclosure.

FIGS. 20A-B are schematic illustrations of one example structured light projector with more than one light source, in accordance with some applications of the present disclosure.

FIGS. 21A-B are schematic illustrations of different ways to combine light sources of different wavelengths in a single structured light projector, in accordance with some applications of the present disclosure.

FIG. 22 illustrates a block diagram of an example computing device, in accordance with embodiments of the present disclosure.

### DETAILED DESCRIPTION

Described herein is a method and apparatus for performing intraoral scanning of the internal structure of teeth. In particular, embodiments provide an intraoral scanning system that uses structured light projection of infrared or near infrared (NIR) light to determine properties about the internal structure of teeth. Examples of information that may be determined includes information on caries, dentin, crystal structure, cracks, density, index of refraction, a health property of a tooth, and so on. In embodiments, the index of refraction may be determined or estimated, and may be used to facilitate determination of one or more other internal properties of a tooth. For example, the index of refraction may affect both the bending of a NIR light ray within a tooth as well as the position that the NIR light ray appears in images. In embodiments, patterned infrared light is projected onto teeth by one or more structured infrared light projectors of an intraoral scanner, and the patterned infrared light's interaction with the tooth at various depths within the tooth are captured by one or more cameras of the intraoral scanner. In some embodiments, the patterned infrared light is a sparse pattern of one or more features (e.g., such as spots, lines, a grid, etc.). Images of the patterned infrared light's interaction with the tooth may be captured by cameras, and may be used to determine three-dimensional (3D) information about the internal structure of the tooth, such as the 3D structure of the dentin within the tooth, the thickness of an enamel of the tooth at one or more locations, a location, size, and/or shape of caries in the tooth, the location, size and/or shape of a crack in the tooth, and so on. The discussion herein uses the terms infrared and near-infrared interchangeably. It should be understood that all mentions of infrared light also apply to near-infrared light, and all mentions of near-infrared light also apply to infrared light.

In some embodiments, an intraoral scanner includes an infrared light projector that projects patterned infrared light including one or a few rays of infrared light (e.g., 1-100 rays). In embodiments, the number of infrared light rays that is used is small enough that statistically the infrared light rays will not interfere with each other. This may include, for example, 5-35 infrared light rays in some embodiments. Using just a few rays of infrared light strongly reduces the amount of scattering and stray light in the system. Furthermore, using just a few rays of infrared light enables cameras to follow the path of the light as it is affected by the internal structure of the tooth (e.g., the semi-crystalline enamel of the tooth). When the infrared light rays (e.g., which may be highly directional, coherent, monochromatic infrared light output by a laser such as a laser diode) encounters the enamel of a tooth, the structure of the enamel cause some scattering of the light ray. The scattering makes the infrared light beam visible to an observing camera. Instead of the light travelling directly forward (as it would in clear air), some of the light is redirected toward the camera by the enamel, allowing the path of the infrared light ray through the enamel to be detected by the camera.

When an infrared ray is shone on a tooth, and viewed by a camera from an angle, we expect to see (in the camera image):
a) the location that the infrared light ray hit the tooth (due to the light ray diffusively scattering back off of the enamel);
b) the enamel region within the tooth (due to a low level of scattering as the infrared light ray travels through the enamel);
c) the location within the tooth that the infrared light ray hit the dentin (due to a high level of scattering at the dentin due to the dentin not having a crystalline structure);
d) the location of any other scattering material within the tooth (e.g., an internal structure such as a caries) in the infrared light ray's path (e.g., due to a high level of scattering at the interface with the other scattering material); and
e) any other reflecting surface (e.g., a crack) in the infrared light ray's path (e.g., due to a change in the index of refraction at the interface with the reflecting surface).

The path that an infrared light ray travels inside the enamel of a tooth may be a straight line, or may be curved if the index of refraction is changing. This curve could also be valuable for analysis on the tooth structure. For example, the curved path can provide information on how the enamel is structured. In some embodiments, the singly scattered light of an infrared light ray will also curve on its way to the camera, which is taken into consideration in embodiments to properly determine the amount of curvature of the infrared light ray that is due to the internal structure of the enamel. Cracks in the enamel will be seen as abrupt direction changes of the infrared light ray. A caries in the enamel destroys the crystal structure of the enamel and will scatter the infrared light ray.

One or more infrared structured light projectors may project patterned infrared light that includes a plurality of projected pattern features. One or more cameras may capture images that include captured pattern features generated by the projected pattern features interacting with the surface and interior of one or more teeth. A correspondence algorithm may be solved to map captured pattern features to projected pattern features. Each determined correspondence of a projected pattern feature to a captured pattern feature may be at a 3D coordinate that can be determined based on known positions and orientations of the camera relative to the pattern projector and each of its projected pattern features (and their corresponding projected infrared light rays). In an example, a structured light projector has a first orientation, one or more cameras each has a respective second orientation, and the respective second orientation of each of the one or more cameras has an angle of 5-25 degrees relative to the first orientation. For correspondence problems that involve visible light, the light reflects off of the surface of the tooth, and a single intersection of a projected pattern feature and a captured pattern feature may exist for each projected pattern feature (e.g., for each projector ray). However, with infrared light that has a portion reflect off of the surface of the tooth, and a portion that travels through the tooth, scattering light as it travels through the tooth), the correspondence algorithm can have increased complexity. For example, a single pattern feature (e.g., projector ray) may have a first correspondence to a first captured pattern feature where the projector ray reflects off the surface of the tooth, additional correspondences as the ray travels through the tooth (e.g., showing up as a straight or curved line in the tooth), and additional correspondences where the ray interfaces with the dentin of the tooth and experiences increased scattering.

Generally speaking, a denser structured light pattern of infrared light may provide more sampling of the interior of a toot and higher resolution. However, too dense a structured light pattern of infrared light may cause light rays through the enamel of a tooth to cross paths and/or be too close together, making it impossible or difficult to solve a correspondence algorithm to attribute captured pattern features to specific infrared light rays (and associated projected pattern features). In embodiments, the pattern of infrared light that can be successfully used to determine the internal structure of a tooth is a much sparser pattern than the pattern of light that can be successfully used to determine the external 3D structure of the tooth (e.g., tens to hundreds of light rays for infrared light used to map the internal structure of a tooth vs thousands to tens of thousands or more of light rays for visible light used to map the external shape of a tooth. When the structured light pattern of infrared light is too dense, sharpness, defocus, and/or micro four thirds (MFT) of captured images may also be limited. For example, for denser patterns the defocus may smear and merge features of the denser pattern. Additionally, a denser structured light pattern may have lower pattern contrast resulting from more light in the system, which may be caused by a combination of (a) stray light that reflects off the somewhat glossy surface of the teeth and may be picked up by the cameras, and (b) percolation, i.e., some of the light entering the teeth, reflecting along multiple paths within the teeth, and then leaving the teeth in many different directions. A sparse light pattern as used herein may be an extremely sparse light pattern (e.g., with a number of light rays on the order of ones or tens to hundreds).

A light pattern includes a plurality of pattern features. The pattern features of a light pattern may include, for example, discrete spots of light, discrete lines of light, etc. When projecting a infrared light pattern comprising pattern features onto a surface of a tooth and through an interior of the tooth, acquired images of the tooth will comprise a plurality of captured image features corresponding to the pattern features. A pattern feature and an image feature may be an individual well-defined location in the light pattern. Examples of image features and pattern features include corners, edges, vertices, points, transitions, dots, stripes, and so on.

Embodiments provide improved techniques for using infrared light to determine properties about the internal structure of teeth. Embodiments enable 3D models of dental arches to be generated that include 3D information about the internal structure of teeth (e.g., a 3D model of the dentin of a tooth, of caries in a tooth, of a crack in the enamel of a tooth, and so on).

In some particular applications of the present disclosure, an apparatus is provided for intraoral scanning (i.e., an intraoral scanner), the apparatus including an elongate wand with a probe at the distal end. During a scan, the probe may be configured to enter the intraoral cavity of a subject. Multiple light projectors (e.g., miniature structured light projectors, which may include infrared structured light projectors and visible structured light projectors) as well as multiple cameras (e.g., miniature cameras) may be coupled to a rigid structure disposed within a distal end of the probe. Each of the light projectors transmits light using a light source, such as a laser diode, light emitting diode (LED), etc. Each of the structured light projectors may be configured to project a pattern of light (e.g., visible and/or infrared light) defined by a plurality of projector rays when the light source is activated. Some of the structured light projectors may project visible light at one or more visible wavelengths, and some of the structured light projectors may project infrared or NIR light. In some embodiments, the visible structured light pattern and the infrared structured light pattern are projected at a same time. In some embodiments, the visible structured light pattern and the infrared structured light pattern are alternatively projected at different times.

In some applications, a method is provided for generating a digital three-dimensional (3D) model of an intraoral surface and optionally of the internal structure of one or more teeth. The 3D model may be a point cloud, from which an image of the three-dimensional intraoral surface may be constructed. The resultant image of the 3D model, while generally displayed on a two-dimensional screen, contains data relating to the three-dimensional structure of the scanned 3D surface and/or of the internal tooth structure, and thus may typically be manipulated so as to show the scanned 3D surface from different views and perspectives. Additionally, a physical three-dimensional model of the scanned 3D surface may be made using the data from the three-dimensional model. As discussed above, the 3D model may be a 3D model of a dental arch, and may include 3D information about internal tooth structures, such as 3D internal surfaces of the dentin of one or more teeth.

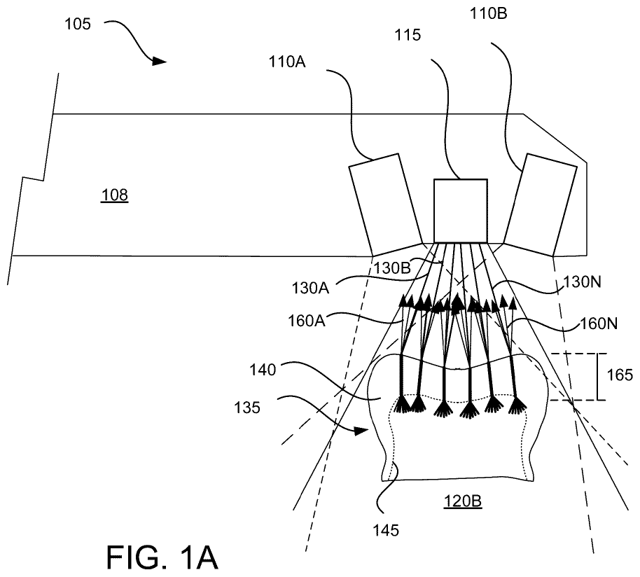

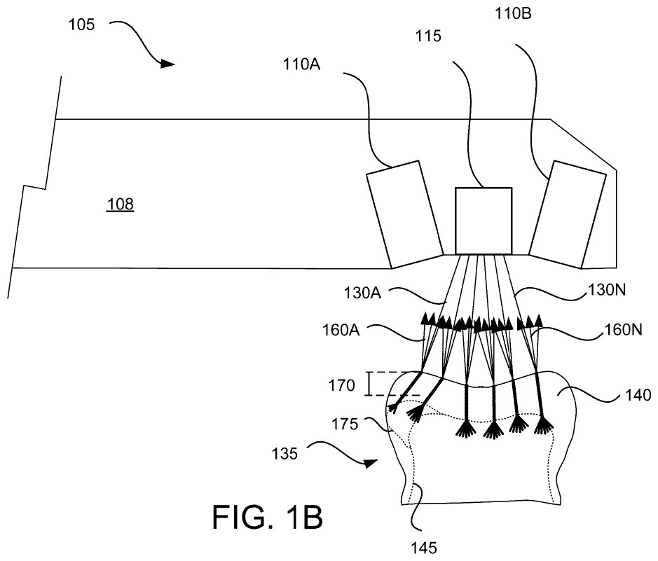

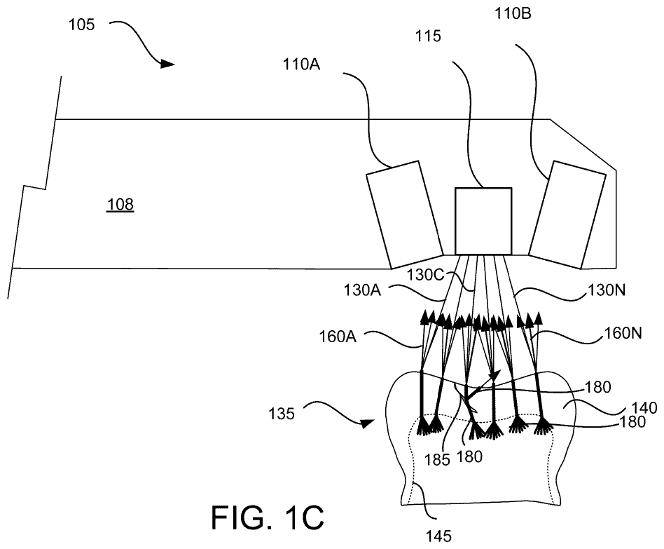

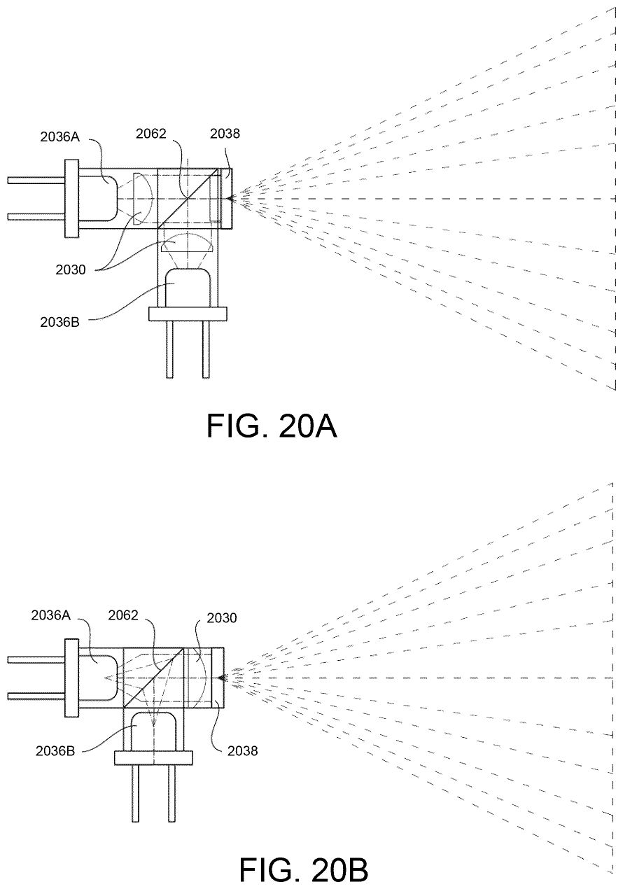

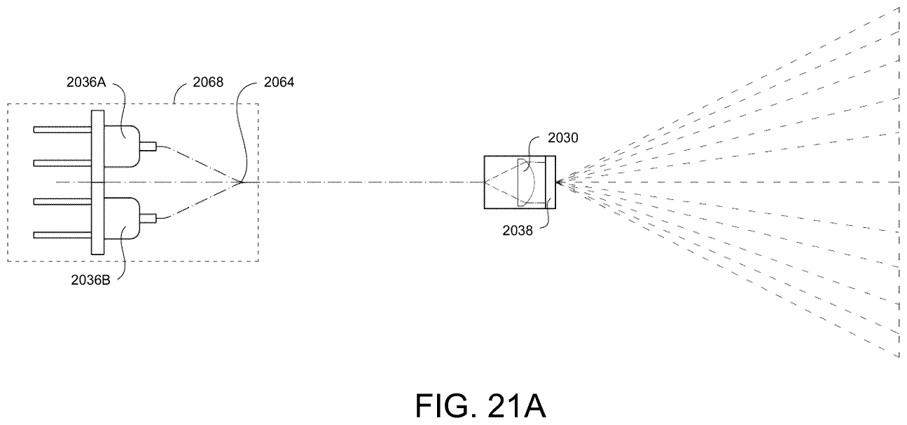

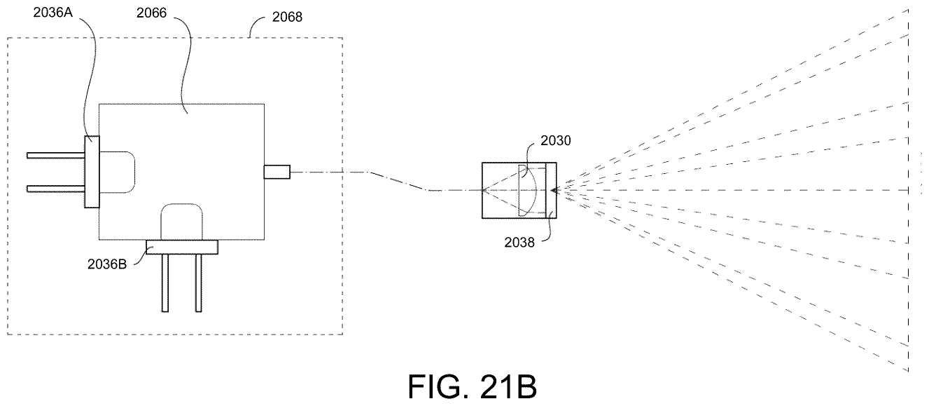

Turning now to the figures, FIG. 1A illustrates an intraoral scanner 105 imaging an internal structure of a tooth 135 using a projected infrared light pattern, in accordance with embodiments of the present disclosure. Intraoral scanner 105 comprises a plurality of structured light projectors and a plurality of cameras in a probe 108 of the intraoral scanner 105. In embodiments, the intraoral scanner 105 includes multiple structured light projectors that project patterned visible light and one or more structured light projectors that project patterned infrared or NIR light. In some embodiments, a single structured light projector may project both patterned infrared light and patterned visible light, which may be done concurrently or in an alternating fashion (e.g., in which the system alternates between projecting an infrared light pattern and a visible light pattern). In embodiments, the patterned infrared light may have a wavelength of 850 nm, 900 nm, 1300 nm, or other wavelengths in the infrared or near-infrared spectrum. A wavelength of 1300 nm may provide improved penetration of teeth in some embodiments. In embodiments, the patterned visible light may include one or more patterns, each comprising light of a particular wavelength. For example, the patterned visible light may include a pattern of blue light, a pattern of green light and/or a pattern of red light. Some examples of structured light projectors that can project both infrared light and visible light are set forth below with reference to FIGS. 20A-21B. For the sake of clarity, intraoral scanner 105 is shown with just a single structured light projector 115 that projects a pattern of infrared light including infrared light rays 130A, 130B, through 130N and two cameras 110A-B. However, it should be understood that in practice the intraoral scanner 105 would have more structured light projectors and more cameras than those shown, including both infrared structured light projectors and visible wavelength structured light projectors (or structured light projectors capable of projecting both an infrared light pattern and a visible light pattern). Additionally, the intraoral scanner 105 may include one or more non-structured light projectors that project non-structured or smooth light (e.g., white light).

As shown, structured light projector 115 projects a pattern of infrared light rays 130A-N onto a tooth 135. The tooth 135 includes an enamel 140 and a dentin 145. The cameras 110A-B and light projector 115 may be disposed in the probe 108 along a longitudinal axis of the probe (e.g., along a longitudinal axis of the intraoral scanner and/or wand), such as at a distal end of the probe 108 and/or wand as shown.

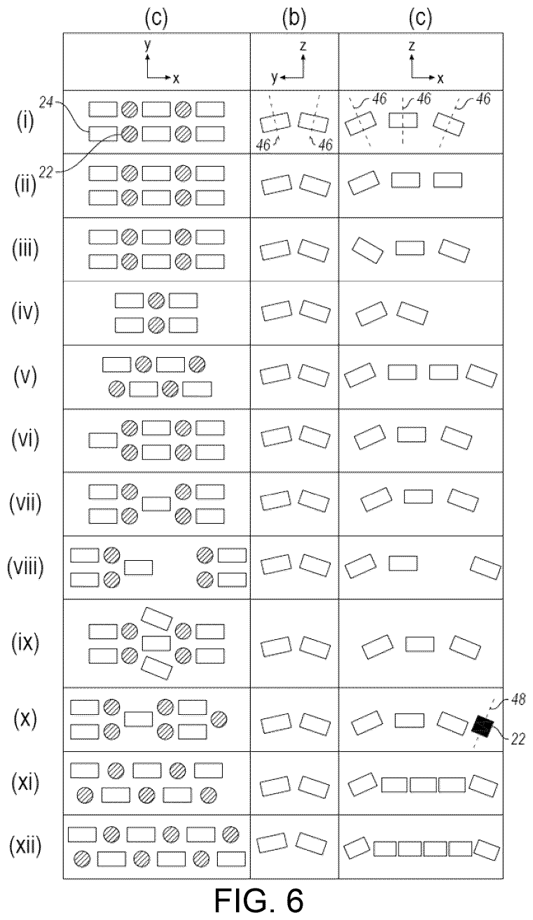

In some embodiments, structured light projectors and cameras are arranged in a pattern in a distal end of probe 108. Examples of some arrangements of structured light projectors and cameras are shown in FIG. 6. In some embodiments, multiple component groupings (also referred to as scan units) are included in the distal end of the probe. Structured light projector 115 and cameras 110A-B may form a portion of one component grouping that may also include two more cameras disposed about structured light projector 115, and another structured light projector (not shown) and additional cameras (not shown) disposed about the other structured light projector may form a second component grouping. The component groupings may be arranged along the longitudinal axis of the probe of the intraoral scanner 105 in embodiments. In some embodiments, each scan unit includes a single light projector (or a single infrared light projector and a single visible wavelength light projector) and four or more cameras disposed about the light projector(s). For example, each scan unit may include a camera on either side of the light projector along the longitudinal axis of the probe and a camera on either side of the light projector along the transverse axis of the probe. In embodiments, all cameras and all light projectors (e.g., all scan units) are positioned to face directly towards an object to be scanned. For example, the light projectors and cameras may be positioned approximately orthogonal to the longitudinal axis of the probe (e.g., within 35 degrees of orthogonal to the longitudinal axis). In some embodiments, all cameras and all light projectors (e.g., all scan units) are positioned to face a mirror (not shown) in the probe, and the mirror reflects projected light onto an object to be scanned and projects captured light from the object to be scanned back to the cameras. For example, the light projectors and cameras may be positioned approximately parallel to the longitudinal axis of the probe (e.g., within 35 degrees of parallel to the longitudinal axis). In some embodiments, some (e.g., one or more) cameras and/or light projectors (e.g., scan units) are positioned to directly face an object to be scanned while other cameras and/or light projectors (e.g., scan units) are positioned to face a mirror within the probe of the intraoral scanner 105. As shown, the structured light projector 115 has an AFOI that causes the FOI of the light projector 115 to increase with distance/depth.

As shown, infrared light rays 130A-N travel in a straight line until they interface with (e.g., hit) the surface of tooth 135. At the point of impact with the surface of the tooth 135, a portion of the infrared light rays 130A-N reflects and/or scatters off of the tooth 135, generating reflected/scattered infrared light rays 160A-N. These reflected/scattered light rays may be captured by the cameras 110A-B as captured patterned light features. A correspondence algorithm may be solved that determines correspondence between projected infrared light rays (projected pattern features) and corresponding camera rays (e.g., captured pattern features). The solution to the correspondence algorithm may indicate the 3D position of the point at which the infrared light ray hit the surface of the tooth.

A portion of the infrared light rays 130A-N continue to travel through the dentin 140 of the tooth 135. However, depending on the angle of impact of the light rays 130-N with the tooth and the index of refraction (which may be uniform or non-uniform within the tooth), the direction of the infrared light rays 130A-N may change in the tooth (as shown in the example). As the infrared light rays travel through the enamel 140, a small amount of scattering of the infrared light rays 130A-N may be caused by the enamel. This scattering may cause a line (e.g., straight or curved) of the light rays 130A-N traveling through the enamel to be captured. In the illustrated example, the light rays 130A-N traveling through the enamel are shown as straight lines. However, it should be understood that in many instances the light rays 130A-N would travel along a curved and/or complex path as they propagate through the enamel, which would result in non-straight lines.

The correspondence algorithm may be solved to determine a projected light ray 130A-N that corresponds to each captured line. Additionally, where each projected infrared light ray 130A-N interfaces with the dentin 145, a large amount of light scattering may occur. This may cause the points at which the infrared light rays 130A-N interface with the dentin to show up as relatively bright spots (or other shapes depending on the pattern of the projected structured infrared light) in relation to the brightness of the lines associated with the projected infrared light rays 130A-N. In the illustrated example, the light rays shown to scatter within the dentin are shown with regular or relatively uniform scattering. It should be understood that in many instances the scattering would be less regular and/or less uniform than what is shown in the illustrated examples. The correspondence algorithm may be solved for each of these captured bright spots (or other captured pattern features) at which the infrared light rays hit the dentin, to determine which projected infrared light rays (and corresponding projected pattern features) correspond to which camera rays (and corresponding captured pattern features). Such solution to the correspondence algorithm may provide the 3D position of a point at which the infrared light ray hit the dentin 145 within the tooth 135. Accordingly, based on solving the correspondence algorithm for multiple infrared light rays, a 3D shape of the dentin 145 may be determined in addition to the 3D shape of the outer surface of the tooth 135. Such information may be used to determine the depth of the dentin 145 and/or thickness of the enamel 140 at any location in/on the tooth 135. For example, enamel thickness 165 is shown, which may be measured in embodiments.

FIG. 1B illustrates an intraoral scanner 105 imaging an internal structure of a tooth 135 having a caries 175 using an infrared structured light pattern, in accordance with embodiments of the present disclosure. As in FIG. 1A, intraoral scanner 105 is shown with just a single structure light projector 115 that projects a pattern of infrared light including infrared light rays 130A, 130B, through 130N onto a tooth 135 and two cameras 110A-B that capture images of the structured light pattern projected onto the tooth 135. The tooth 135 includes an enamel 140 and a dentin 145, and further includes a caries 175. As shown in FIG. 1A (in which the tooth 135 did not include any caries), infrared light rays 130A-N reflected/scatter off of the surface of tooth 135, producing reflected/scattered infrared light rays 160A-N that are captured by cameras 110A-B (e.g., that correspond to camera rays of the cameras). Additionally, some amount of the infrared light rays travel through enamel 140 of the tooth 135 until they encounter a highly scattering object (e.g., dentin or caries) within the tooth 135. A few of the infrared light rays traveling through tooth 135 encounter caries 175, and scatter at that point of encounter. In some embodiments, a caries can be distinguished from dentin based on a location within the tooth and/or on a shape. For example, if scattering occurs where enamel is expected, a caries may be identified. Additionally, the behavior of infrared light interaction with caries may differ from the behavior of infrared light interaction with dentin. For example, the level of absorption of infrared light by caries may be different from the level of absorption of infrared light by dentin. Such differences may be used to distinguish between caries and dentin, optionally together with information such as shape and location, in embodiments. Such scattering is captured in images by cameras 110A-B, and can be used to solve a correspondence algorithm and determine 3D coordinates of points of intersection of the infrared light rays with the internal structures (e.g., dentin 145 and/or caries 175). This may enable a shape, size, location, etc. of the caries to be determined in three dimensions. Accordingly, a depth 170, size, etc. of the caries may be measured and reproduced on a 3D model of a dental arch including the scanned tooth.

FIG. 1C illustrates an intraoral scanner 105 imaging an internal structure of a tooth 135 having a crack 185 using an infrared structured light pattern, in accordance with embodiments of the present disclosure. As in FIG. 1A, intraoral scanner 105 is shown with just a single structured light projector 115 that projects a pattern of infrared light including infrared light rays 130A, 130B, through 130N onto a tooth 135 and two cameras 110A-B that capture images of the structured light pattern projected onto the tooth 135. The tooth 135 includes an enamel 140 and a dentin 145, and further includes a crack 185. As shown in FIG. 1A (in which the tooth 135 did not include any crack), infrared light rays 130A-N reflect/scatter off of the surface of tooth 135, producing reflected/scattered infrared light rays 160A-N that are captured by cameras 110A-B (e.g., that correspond to camera rays of the cameras). Additionally, some amount of the infrared light rays travel through enamel 140 of the tooth 135 until they encounter a highly scattering object (e.g., dentin or caries) within the tooth 135 and/or a reflective object or surface that will cause the infrared light rays to change direction within the tooth 135. A crack in a tooth acts as a boundary, which may both reflect and refract incident light. A single infrared light ray traveling through tooth 135 is shown to encounter crack 185, and a portion of the light ray abruptly changes direction and results in a reflected infrared light ray 180, while a portion of the infrared light ray changes direction and results in a refracted infrared light ray 182. Such an abrupt change of direction is captured in images by cameras 110A-B, and can be used to solve a correspondence algorithm and determine 3D coordinates of points of intersection of the infrared light rays with the internal structure (e.g., crack 185) at which an abrupt change in direction occurred. This may enable a shape, size, location, etc. of the crack to be determined in three dimensions.

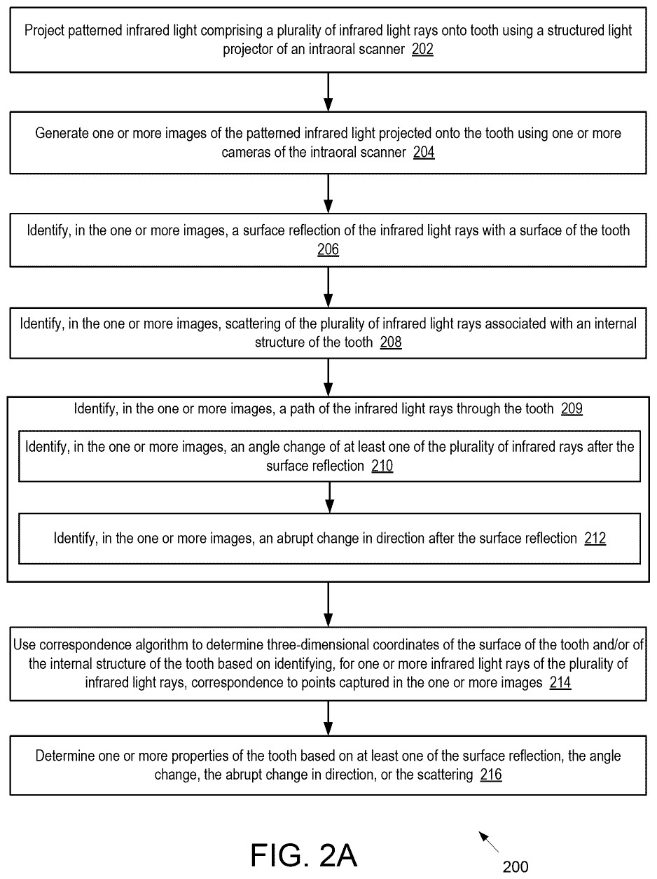

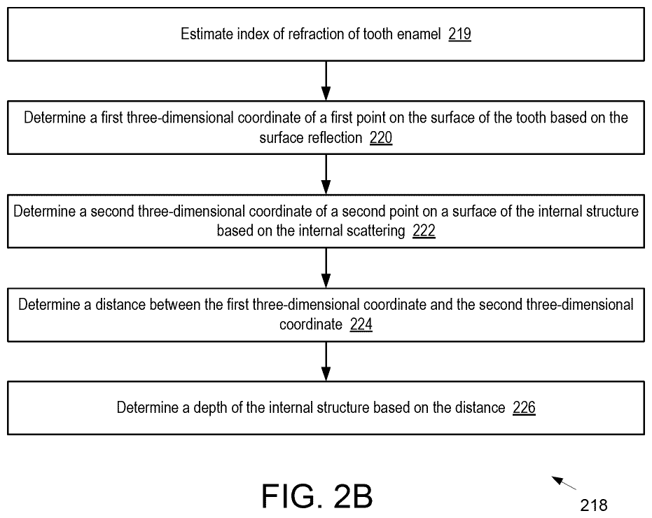

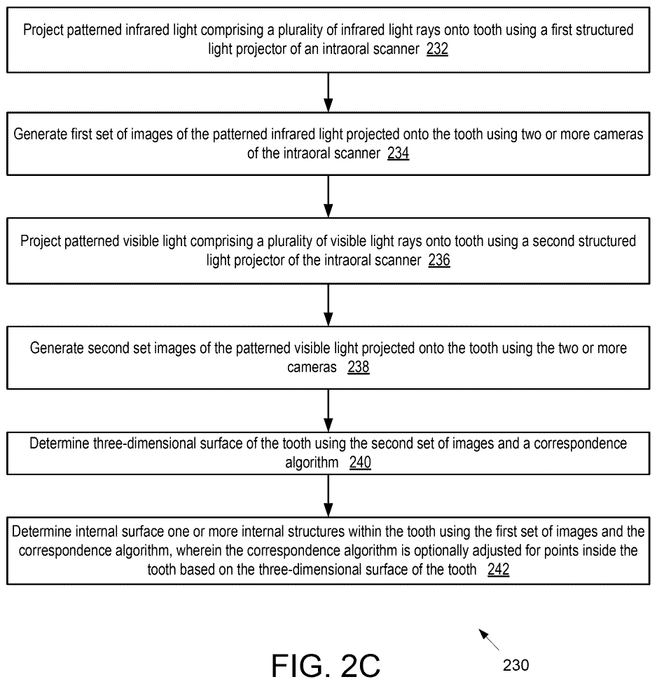

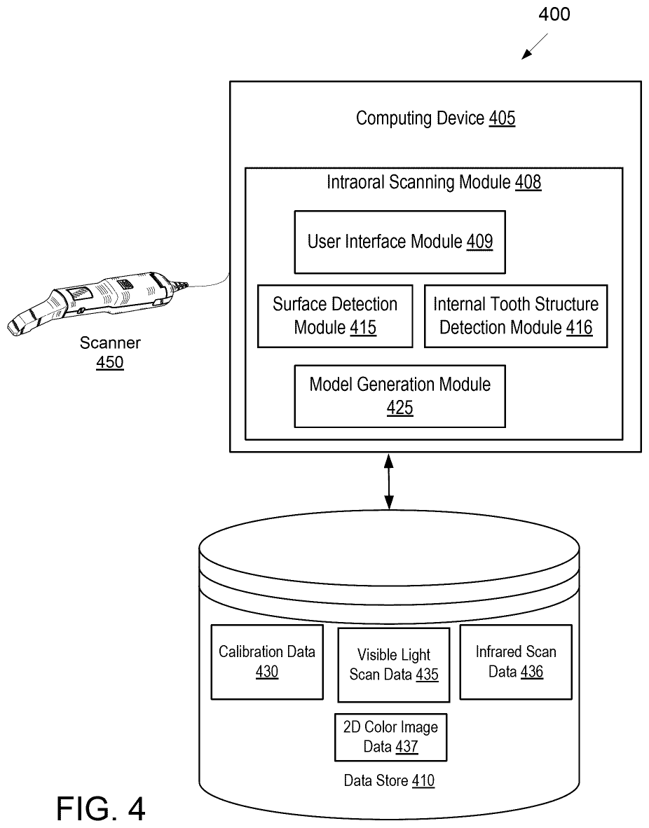

FIGS. 2A-C illustrate flow diagrams for methods of generating a virtual 3D model of an internal structure of a tooth using patterned infrared light, in accordance with embodiments of the present disclosure. The methods of FIGS. 2A-C may be performed by processing logic that comprises hardware (e.g., circuitry, dedicated logic, programmable logic, microcode, etc.), software (such as instructions run on a processing device), or a combination thereof. In one embodiment, processing logic corresponds to computing device 405 of FIG. 4. In some embodiments, some aspects of the methods may be performed by an intraoral scanner (e.g., scanner 450 of FIG. 4), while other aspects of the methods are performed by a computing device that may be operatively coupled to an intraoral scanner (e.g., computing device 405 of FIG. 4). The computing device may be a local computing device that is connected to the intraoral scanner via a wired connection or via a wireless connection. Alternatively, the computing device may be a remote computing device that connects via a network (e.g., the Internet and/or an intranet) to the intraoral scanner or to a local computing device that is in turn connected to the intraoral scanner.

FIG. 2A illustrates a flow diagram for a method 200 of imaging an internal structure of a tooth based on projecting patterned infrared light, in accordance with embodiments of the present disclosure. At block 202 of method 200, processing logic causes a first light projector of an intraoral scanner to project a light pattern of infrared (or NIR) light comprising first pattern features. The light projector may project coherent light in the infrared or near infrared spectrum in embodiments. The processing logic may be processing logic of the intraoral scanner and/or of a computing device connected to the intraoral scanner over a wired or wireless connection. The light pattern may be projected onto a dental site (e.g., an oral structure, dental arch, tooth, etc.) in embodiments.

At block 204, processing logic causes cameras of the intraoral scanner to image the projected infrared light pattern to produce intraoral scan data. The intraoral scanner may include a plurality of cameras that capture the projected infrared light pattern. Some cameras may capture only portions of the infrared light pattern.

The intraoral scan data (also referred to as an intraoral scan) may include a set of images generated at a same time or approximately the same time, each image having been generated by a different camera. Other intraoral scans may also be received, each including a set of images. Each intraoral scan may include image data generated by multiple cameras of the intraoral scanner. In an example, two or more cameras of an intraoral scanner may each generate an intraoral image, and the multiple intraoral images may be combined based on the known positions and orientations of the respective two or more cameras to form an intraoral scan. In one embodiment, each intraoral scan may include captured image features that correspond to pattern features that were projected onto a region of the dental site (e.g., tooth) by one or more structured light projectors projecting a pattern of infrared light rays. Image features as used herein are features of a light pattern that are captured in an image (as opposed to pattern features, which are features of a projected light pattern as projected). Image features correspond to camera rays, while pattern features correspond to projector rays (i.e., projected infrared light rays). For example, one or more structured light projectors may be driven to project a distribution of discrete unconnected spots of infrared light or another pattern on an intraoral surface, and the cameras may be driven to capture images of the projection. The image captured by each camera may include image features corresponding to at least one of the pattern features (e.g., projected spots, etc. at multiple locations on and/or within a tooth as the respective infrared light rays corresponding to the pattern features progress through the interior of the tooth). In embodiments, a single pattern feature may correspond to multiple image features (e.g., a path of image features that correspond to a trail of the infrared light rays traveling through the tooth). Together the images generated by the various cameras at a particular time may form an intraoral scan (e.g., first intraoral scan data).

Each camera may include a camera sensor that has an array of pixels, for each of which there exists a corresponding ray in 3D space originating from the pixel whose direction is towards an object being imaged; each point along a particular one of these rays, when imaged on the sensor, will fall on its corresponding respective pixel on the sensor. As used throughout this application, the term used for this is a “camera ray.” Similarly, for each projected spot or other feature from each projector there exists a corresponding projector ray. Each projector ray corresponds to a respective path of pixels on at least one of the camera sensors, i.e., if a camera sees a spot projected by a specific projector ray, that spot will necessarily be detected by a pixel on the specific path of pixels that corresponds to that specific projector ray. Values for (a) the camera ray corresponding to each pixel on the camera sensor of each of the cameras, and (b) the projector ray corresponding to each of the projected pattern features from each of the projectors, may be stored as calibration data, as described hereinbelow.

A dental practitioner may have performed intraoral scanning of the dental arch (e.g., one or more teeth on the dental arch) to generate a plurality of intraoral scans of the dental arch (e.g., teeth on the dental arch). This may include performing intraoral scanning of a partial or full mandibular or maxillary arch, or a partial or full scan of both arches (e.g., a scan of a single tooth or a few teeth). Performing the intraoral scanning may include projecting an infrared light pattern onto an intraoral surface of a patient using an infrared structured light projector and optionally projecting a second light pattern of visible light onto the intraoral surface using a second light projector, wherein the light patterns are non-coded. Further discussion of performing scanning using both structured infrared light and structured visible light is provided below with reference to FIG. 2C. Performing the intraoral scanning may further include capturing a plurality of scans or images of the projected light patterns using two or more cameras disposed in the probe. While method 200 is described with reference to projection and capture of infrared light patterns, it should be understood that a visible light pattern may also be projected and captured in parallel or alternately with the infrared light pattern.

At block 206, processing logic identifies, in the one or more images of the patterned infrared light projected onto the dental site (e.g., onto one or more teeth), a surface reflection and/or scattering of the infrared light rays with a surface of the dental site (e.g., a surface of the one or more teeth). The point of surface reflection/scattering at the surface of a tooth that is captured in the images may appear, for example, as a point, spot or other pattern feature in one or more images. In some embodiments, the location of the surface reflection/scattering at the surface of the dental site (e.g., tooth) may be determined using standard image processing techniques such as edge detection, thresholding, feature extraction, point detection, object detection, and so on. In some embodiments, the image(s) are input into a trained machine learning model that performs object detection and/or segmentation, and that outputs an identification of detected image features caused by reflection/scattering of a projected infrared light pattern with a surface of a tooth. In one embodiment, the trained ML model processes the one or more images and outputs, for each infrared light ray of the plurality of infrared light rays captured in the one or more images, an estimated coordinate of an intersection of the infrared light ray with the internal structure and a class of the internal structure.

At block 208, processing logic identifies, in the one or more images of the patterned infrared light projected onto the dental site (e.g., onto one or more teeth), a scattering of the infrared light rays with a surface of the of an internal structure within the dental site (e.g., a surface of a dentin and/or caries within a tooth). The point of surface scattering at the surface of the internal structure that is captured in the images may appear, for example, as a point or other pattern feature at the surface of the internal structure and/or as a light cone spreading from a point on a surface of the internal structure in one or more images. In some embodiments, the location of the scattering at the surface of the internal structure of a tooth may be determined using standard image processing techniques such as edge detection, thresholding, feature extraction, point detection, object detection, and so on. In some embodiments, the image(s) are input into a trained machine learning model that performs object detection and/or segmentation, and that outputs an identification of detected image features caused by caused by scattering of a projected infrared light pattern with a surface of an internal structure within a tooth.

At block 209, processing logic identifies, in the one or more images of the patterned infrared light projected onto the dental site (e.g., onto one or more teeth), a path of one or more infrared light rays travelling through the enamel of the one or more teeth. A small amount of scattering may occur within the enamel due to the crystalline structure of the enamel. For one or more infrared rays, this small amount of scattering may be captured in images as a line or path traversed by the one or more infrared rays. In some embodiments, the path of infrared light rays traveling through a tooth's enamel may be determined using standard image processing techniques such as edge detection, thresholding, feature extraction, point detection, object detection, and so on. In some embodiments, the image(s) are input into a trained machine learning model that performs object detection and/or segmentation, and that outputs an identification of detected image features caused by scattering of a projected infrared light pattern with the enamel of a tooth as the infrared light rays of the projected infrared light pattern travel through the enamel of the tooth.

In embodiments, information about the internal structure of a tooth may be determined based on the path of the infrared rays traveling through the enamel of the tooth (e.g., a path traveled after the point at which surface reflection is detected). For example, at block 210 processing logic may identify, in one or more images, an angle change of at least one of the plurality of infrared light rays after the surface reflection. The angle change may be determined by identifying one or more locations in an image at which a direction of an infrared light ray has changed and measuring an angle between a direction of the infrared light ray before the direction change and a direction of the infrared light ray after the direction change. In embodiments, the determined angle may be used to determine properties of the tooth's enamel (and/or health properties of a tooth), such as an index of refraction (e.g., a change in the index of refraction), a crystal structure, and so on. If the angle change is abrupt, then this may be an indication of a crack in the enamel of the tooth. Accordingly, at block 212 processing logic may identify an abrupt change in direction of the infrared light ray after the surface reflection. This information may be used to determine one or more properties about a crack in the tooth in some embodiments.

In some embodiments, the one or more images are input into a trained machine learning model, which may output information on a location of an interface of infrared light rays with a tooth surface, a path of the infrared light rays within the enamel of the tooth, a location of an interface of the infrared light rays with a crack, a location of an interface of the infrared light rays with one or more internal structures (e.g., dentin or caries), and so on. In some embodiments, the machine learning model performs object detection and/or segmentation, and outputs indications of one or more types of detected tooth features (e.g., which may correspond to captured pattern features of the infrared light pattern). For example, the machine learning model may output bounding boxes around each identified point or intersection or feature on a surface of a tooth, point or intersection or feature on a caries, point or intersection or feature on a dentin, point or intersection or feature on a crack in a tooth, and so on. In another example, the machine learning model may output one or more pixel maps identifying pixels associated with one or more types of tooth features. In some embodiments, 2D coordinates within each image of each of the identified features (e.g., captured pattern feature on a surface of the tooth, captured pattern feature on a surface of an internal structure, pints on a path of an infrared light ray in a tooth enamel, etc.) may be determined.

In embodiments, one or more machine learning models are trained to perform detection and classification of the impingement of infrared light rays on one or more tooth structures (e.g., enamel, dentin, caries, crack, etc.). One type of machine learning model that may be used to perform some or all of the above asks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

For model training, a training dataset containing hundreds, thousands, tens of thousands, hundreds of thousands or more intraoral scans, images and/or 3D models should be used to form a training dataset. In embodiments, up to millions of cases of patient dentition that may have underwent a prosthodontic procedure and/or an orthodontic procedure may be available for forming a training dataset, where each case may include various labels of one or more types of useful information. Each case may include, for example, data showing a 3D model, intraoral scans, height maps, color images, NIRI images, etc. of one or more dental sites, data showing pixel-level segmentation of the data (e.g., 3D model, intraoral scans, height maps, color images, NIRI images, etc.) into various dental classes (e.g., tooth, restorative object, gingiva, moving tissue, upper palate, etc.), data showing one or more assigned classifications for the data (e.g., caries, cracks, tooth surface, etc.), and so on. This data may be processed to generate one or multiple training datasets for training of one or more machine learning models.

In one embodiment, generating one or more training datasets includes gathering one or more intraoral scans generated using patterned infrared light with labels. The labels may identify locations at which infrared light rays interface with a tooth surface, a crack, a dentin, a caries, and so on. Processing logic may gather a training dataset comprising 2D or 3D images, intraoral scans, 3D surfaces, 3D models, height maps, etc. of dental sites (e.g., of teeth) having one or more associated labels (e.g., pixel-level labeled classes in the form of maps (e.g., probability maps) in embodiments. One or more images, scans, surfaces, and/or models and optionally associated probability maps in the training dataset may be resized in embodiments. For example, a machine learning model may be usable for images having certain pixel size ranges, and one or more image may be resized if they fall outside of those pixel size ranges. The images may be resized, for example, using methods such as nearest-neighbor interpolation or box sampling. The training dataset may additionally or alternatively be augmented. Training of large-scale neural networks generally uses tens of thousands of images, which are not easy to acquire in many real-world applications. Data augmentation can be used to artificially increase the effective sample size. Common techniques include random rotation, shifts, shear, flips and so on to existing images to increase the sample size.

To effectuate training, processing logic inputs the training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the images and/scans generated using patterned infrared light into the machine learning model one at a time. Each input may include data from an image or intraoral scan in a training data item from the training dataset. The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce. For example, for an artificial neural network being trained to perform classification of a tooth surface, caries, dentin and/or crack, there may be a first class (tooth surface), a second class (caries), a third class (dentin), and/or a fourth class (crack). Moreover, the class, prediction, etc. may be determined for each pixel in the image/scan/surface, may be determined for an entire image/scan/surface, or may be determined for each region or group of pixels of the image/scan/surface. For pixel level segmentation, for each pixel in the image/scan/surface, the final layer applies a probability that the pixel of the image/scan/surface belongs to the first class, a probability that the pixel belongs to the second class, a probability that the pixel belongs to the third class, and/or one or more additional probabilities that the pixel belongs to other classes.

Accordingly, the output may include one or more prediction and/or one or more a probability map. For example, an output probability map may comprise, for each pixel in an input image/scan/surface, a first probability that the pixel belongs to a first dental class, a second probability that the pixel belongs to a second dental class, and so on.

Processing logic may then compare the generated probability map and/or other output to the known probability map and/or label that was included in the training data item. Processing logic determines an error (i.e., a classification error) based on the differences between the output probability map and/or label(s) and the provided probability map and/or label(s). Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node).

Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

In one embodiment, at block 214 a correspondence algorithm is run using the determined 2D coordinates of the identified features/points (e.g., where an infrared light ray hits a tooth surface, where an infrared light ray hits a tooth crack, where an infrared light ray hits an internal structure within a tooth, etc.) and calibration information to determine 3D coordinates of the features/points. The images of the different cameras may have been generated at the same time and may constitute an image set in embodiments. Multiple sets of images may be generated over time. In embodiments, triangulation between images in a set of images (e.g., between the cameras that captured the images in the set of images) and/or an estimated index of refraction may be used together with the correspondence algorithm to determine the 3D coordinates of the features/points.

Running the correspondence algorithm may include, for each set of images, determining a correspondence between pattern features and/or projected infrared light rays in the infrared pattern of light and image features by determining intersections of infrared projector rays (e.g., corresponding to one or more of the pattern features) with camera rays corresponding to the one or more captured image features (e.g., locations in images of intersection of infrared light rays with a tooth surface, with a dentin within a tooth, with a caries within a tooth, with a crack within a tooth, etc.) in three-dimensional (3D) space based on calibration data that associates the camera rays corresponding to pixels on the camera sensor of each of the two or more cameras to the infrared projector rays. Running the correspondence algorithm may include first determining the correspondence between the pattern features and the image features in the 3D space for a first subset of the pattern features that are associated with a highest number of image features. Once correspondences have been found for the first subset of the pattern features that are associated with a highest number of image features, processing logic may subsequently determine the correspondence between the pattern features and the image features in the 3D space for a second subset of the pattern features that are associated with a next highest number of image features. This process may be repeated, each time for pattern features associated with a next highest number of image features.

Processing logic may determine depths associated with pattern features (e.g., depths at which infrared light rays interface with a tooth surface, with a crack in a tooth, with an internal structure within a tooth, etc. based on correspondence to image features in one or more images, and possibly further based on triangulation and/or an estimated index of refraction. The depths may be combined with x,y information also determined from the images to determine 3D coordinates of the pattern features, and thus 3D coordinates of points on a scanned tooth surface and internal feature(s) within a tooth. The depths may be determined using a correspondence algorithm and stored calibration values, and optionally further using triangulation and/or an estimated index of refraction. The stored calibration values may associate camera rays corresponding to pixels on a camera sensor of each of a plurality of cameras to a plurality of infrared projector rays.

Processing logic may run the correspondence algorithm using the stored calibration values in order to identify a three-dimensional location for each projected point or feature (referred to as a pattern feature) on a surface of a scanned 3D surface or internal structure within a tooth. In one embodiment, for a given projector ray, the processor “looks” at the corresponding camera sensor path on one of the cameras. Each detected image feature along that camera sensor path will have a camera ray that intersects the given projector ray (and thus the pattern feature). That intersection defines a three-dimensional point in space. The three-dimensional point in space may be affected by an index of refraction of the enamel of the tooth for correspondence determined for points within the tooth. Accordingly, in some embodiments the index of refraction is estimated and used to together with the intersection to determine the 3D point in space.

The processor may search among the camera sensor paths that correspond to that given projector ray on the other cameras and may identify how many other cameras, on their respective camera sensor paths corresponding to the given projector ray, also detected an image feature whose camera ray intersects with that three-dimensional point in space. As used herein throughout the present application, if two or more cameras detect image features whose respective camera rays intersect a given projector ray at the same three-dimensional point in space, the cameras are considered to “agree” on the image feature being located at that three-dimensional point. Accordingly, the processor may identify three-dimensional locations of the projected pattern of light based on agreements of the two or more cameras on there being the projected pattern of light by projector rays at certain intersections. Such intersections may be with a tooth surface, a crack in a tooth, a dentin in a tooth, a caries in a tooth, and so on. The process is repeated for the additional image features along a camera sensor path, and the image feature for which the highest number of cameras “agree” is identified as the image feature that is being projected onto the surface from the given projector ray (and thus that corresponds to a particular pattern feature). A three-dimensional position on or in the tooth is thus computed for that image feature, including the depth for that image feature. Accordingly, a depth of a first intraoral 3D surface may be determined (which may include depths of multiple different points on the surface of the first intraoral 3D surface).

If only points on a surface are to be considered, then once a position on of an image feature on or in a tooth is determined for a specific image feature, the projector ray that projected that image feature, as well as all camera rays corresponding to that image feature, may be removed from consideration for further iterations of solving the correspondence algorithm for other image features in the images. However, with the use of structured infrared light that travels through an interior of a tooth, even after a correspondence is found between a projector ray and a camera ray, that projector ray may not be removed from consideration because it might also correspond to other camera rays at other points of intersection with internal structures/objects within the tooth. In some embodiments, different types of intersections may be considered, and after a particular type of intersection is identified, the projector ray associated with an intersection with a camera ray for that particular type of intersection may be removed from consideration for that type of intersection. In one embodiment, the correspondence algorithm is separately run multiple times for a given projector ray, each time for a different type of intersection (e.g., once to identify a tooth surface, once to identify a dentin surface and/or caries, once to identify tooth cracks, and so on). Additionally, or alternatively, the correspondence algorithm may be run again for a next projector ray. This may be repeated until depths are determined for many or all image features (or there are no remaining image features for which a solution can be found with a threshold level of confidence).

At block 216, processing logic may determine one or more properties of the tooth based on at least one of the determined surface reflection, the determined angle change within the tooth enamel, an abrupt angle change within the tooth enamel, or the scattering of infrared light from an internal structure within a tooth (e.g., with a dentin and/or caries). The determined properties may include the 3D shape, size, location/position, volume, depth, etc. of one or more internal structures in a tooth, such as of a dentin, caries, crack, and so on. The determined properties may include an index of refraction of the tooth enamel, which may not be uniform. Other properties of the tooth may also be determined, such as a 3D outer surface of the tooth. In some embodiments, one or more properties of the tooth such as the index of refraction are determined prior to the operations of block 214, and may be used to help solve the correspondence problem.

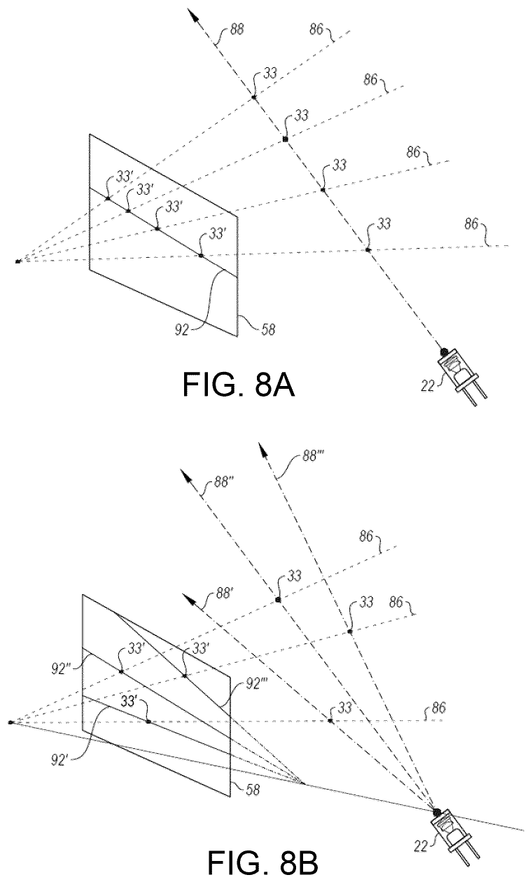

In some embodiments, processing logic generates a 3D model of internal features of a tooth based on the intraoral scan data. Ultimately, identified three-dimensional locations of dentin, caries, cracks, etc. within a tooth may be used to generate a digital three-dimensional model of the internal structures within the tooth. For example, processing logic generates the digital 3D representation of the internal structures within a tooth based on the determined correspondence between the infrared pattern features and the infrared image features in the one or more sets of images. The correspondence algorithm for solving for correspondence between pattern features (e.g., corresponding to projector rays from one or more light projectors) and image features (e.g., corresponding to camera rays from one or more cameras) is described in greater detail below with reference to FIGS. 8A-19.

Processing logic may stitch together the plurality of intraoral scans. This may include registering the first intraoral scan to one or more additional intraoral scans using overlapping data between the various intraoral scans. In one embodiment, performing scan registration includes capturing 3D data of various points of a surface in multiple intraoral scans, and registering the intraoral scans by computing transformations between the intraoral scans. The intraoral scans may then be integrated into a common reference frame by applying appropriate transformations to points of each registered intraoral scan.

In one embodiment, registration is performed for adjacent or overlapping intraoral scans (e.g., successive frames of an intraoral video). Registration algorithms are carried out to register two or more intraoral scans that have overlapping scan data, which essentially involves determination of the transformations which align one scan with the other. Registration may be performed using, for example, an iterative closest point (ICP) algorithm, and may involve identifying multiple points in multiple scans (e.g., point clouds), surface fitting to the points of each scan, and using local searches around points to match points of the overlapping scans. Some examples of ICP algorithms that may be used are described in Francois Pomerleau, et al., “Comparing ICP Variants on Real-World Data Sets”, 2013, which is incorporated by reference herein. Other techniques that may be used for registration include those based on determining point-to-point correspondences using other features and minimization of point-to-surface distances, for example. In one embodiment, scan registration (and stitching) is performed as described in U.S. Pat. No. 6,542,249, issued Apr. 1, 2003, entitled “Three-dimensional Measurement Method and Apparatus,” which is incorporated by reference herein. Other scan registration techniques may also be used.

Registration may include both stitching pairs of intraoral scans sequentially, as well as performing a global optimization that minimizes all pairs of positions together and/or or minimizes all points from all scans one to another. Accordingly, if a scan to scan registration (e.g., using ICP) searches in 6 degrees of freedom (3 translation and 3 rotation) that optimizes the distance of all points from one scan to another, then a global optimization of 11 scans will search in (11−1)×6=60 degrees of freedom for all scans relative to all other scans, while minimizing some distance between all scans. In some cases, this global optimization should give weights to different errors (e.g., edges of scans and/or far points may be given lower weight for better robustness).

The number of points within an interior of a tooth for which 3D coordinates are determined using patterned infrared light may be relatively small compared to the number of points on a surface of a tooth and other dental site for which coordinates are determined using patterned visible light. Accordingly, in some embodiments a 3D surface of one or more teeth is generated by solving the correspondence algorithm based on imaging of patterned visible light projected onto the one or more teeth. The 3D surface of the one or more teeth can further be determined using the 3D coordinates at points on the tooth surface identified from the patterned infrared light. This information may be used to register the infrared images to the 3D surface, and thus to determine accurate relative positioning between internal structures of the tooth determined using the infrared light and the 3D surface of the tooth. Other information such as from an inertial measurement unit (IMU) may also be used to facilitate the registration process.

Processing logic may generate a virtual 3D model of the dental arch, including internal 3D structures within one or more teeth of the dental arch) from the intraoral scans that capture infrared light patterns and from the intraoral scans that capture visible light patterns by integrating data from all intraoral scans into a single 3D model by applying the appropriate determined transformations to each of the scans. Each transformation may include rotations about one to three axes and translations within one to three planes, for example.

In one embodiment, stereo vision techniques, deep learning techniques (e.g., using convolutional neural networks) and/or simultaneous localization and mapping (SLAM) techniques may be used with the scan data from the visible structured light and the scan data from the structured near-infrared light to improve an accuracy of a determined 3D surface and/or 3D internal structures within a tooth and/or to reduce a number of options that processing logic needs to consider when running the correspondence algorithm.

The 3D models of dental arches with improved accuracy that are provided in embodiments may be useful both for prosthodontic (restorative) and orthodontic procedures. By way of non-limiting example, dental procedures may be broadly divided into prosthodontic (restorative) and orthodontic procedures, and then further subdivided into specific forms of these procedures. The term prosthodontic procedure refers, inter alia, to any procedure involving the oral cavity and directed to the design, manufacture or installation of a dental prosthesis at a dental site within the oral cavity, or a real or virtual model thereof, or directed to the design and preparation of the dental site to receive such a prosthesis. A prosthesis may include any restoration such as crowns, veneers, inlays, onlays, and bridges, for example, and any other artificial partial or complete denture. The term orthodontic procedure refers, inter alia, to any procedure involving the oral cavity and directed to the design, manufacture or installation of orthodontic elements at a dental site within the oral cavity, or a real or virtual model thereof, or directed to the design and preparation of the dental site to receive such orthodontic elements. These elements may be appliances including but not limited to brackets and wires, retainers, clear aligners, or functional appliances.

In some embodiments, one or more structured light projectors are used to project one or an infrared structured light pattern that includes one or a few infrared light rays. For example, 2-3 structured light projectors may be used to produce 5-100 infrared light rays. In some embodiments, 9, 16 or 25 infrared light rays are projected in one or more patterns. In some embodiments, fewer than 25 infrared light rays are projected in one or more patterns. This keeps the overall number of infrared light rays per image capture small. During a full scan, multiple such image captures of the tooth are performed from random directions. Also, many of the infrared rays will be observed from many different cameras (due to the multi camera structure of the intraoral scanner). This enables a 3D surface of internal structures of a tooth to be determined and mapped. In an example, assume the length of the jaw is 100 mm, and a tooth is 10×10 mm in size. Cameras may capture images from the tooth from multiple (e.g., three or more) sides. Accordingly, an overall surface of teeth will be under 3000 mm². Assuming the intraoral scanner captures 10 NIRI frames per second, during a 30 second scan, the intraoral scanner will generate 300 captures (e.g., sets of images). In this example, each capture will have 50 infrared light rays hitting the teeth, resulting in 300×50=15,000 infrared light rays hitting the teeth. Assuming a uniform condition, each 1 mm² of a tooth will be hit 5 times (e.g., will have 5 infrared light rays passing through that 1 mm² region). This provides sufficient data to determine a 3D surface of the internal structure of the tooth.

Predictably, each small region of the tooth will be hit by infrared light rays during the scan from multiple directions, and viewed from multiple directions. From the regular (e.g., visible) structured light, the 3D surface of the jaw and teeth can be precisely determined, and the position of the wand relative to the 3D surface during the scan (e.g., at each image capture) can be precisely determined. Processing logic can use this knowledge and all the structured light near-infrared (SL-NIR) images to analyze the internal structure of the tooth based on the behavior of the infrared light rays inside the tooth. For example, processing logic can estimate the index of refraction of the tooth enamel by analyzing the angle change of the infrared light rays. Processing logic can estimate the depth of the dentin from the surface by analyzing the depth of an infrared light ray inside the tooth until it hits the dentin. Accordingly, in embodiments processing logic can analyze carries and dentin shape, volume, position, and depth. Processing logic can also analyze ray direction change in the enamel, which is another way to analyze cracks, and depth of cracks.

In some embodiments, processing logic can enhance image contrast by contrast limited adaptive histogram equalization (CLAHE) and other classical methods such as histogram equalization, gaussian filtering, median filtering, Sobel, Prewitt and Scharr edge detectors, Laplacian of Gaussian, canny edge detector, image thresholding, Fourier transform, watershed segmentation, template matching, Hough transform, principal component analysis (PCA), color space transformations, and so on. In some embodiments, one or more trained machine learning models are used to perform image enhancement. For example, one or more generative models may receive images of teeth with infrared light rays traveling through them, and may generate an output image in which the infrared light rays are enhanced.

In some embodiments, ray tracking may be performed in images and/or across images. Some examples of ray tracking across images (e.g., images taken by a same camera at different times) are described in U.S. Pat. No. 11,563,929, issued Jan. 24, 2023, the entire contents of which are incorporated by reference herein. One way to improve ray tracking in images is by using machine learning methods. In some embodiments, one or more images are processed using a trained machine learning model, wherein the trained machine learning model outputs ray tracking information for the plurality of infrared light rays in the one or more images. Training of machine learning models used to perform ray tracking can be done in different ways. In one example, using each laser on its own will improve contrast and help find true a ray. Multiple lasers may be used all at once, but a ground truth may come from one by one operation. In some embodiments, processing logic can assume very slow movement of the intraoral scanner between scans, and constrain a ground truth result to change slowly, while the machine learning model (e.g., a deep neural network) may be constrained to find a path of one or more infrared light rays from single images. In some embodiments, special targets may be used for training an ML model, in which all the parameters of the tooth are known in advance. In some embodiments, other imaging methods (e.g. CBCT) may be used to map the true tooth structure as a ground truth for training one or more ML models to perform ray tracking.

In some embodiments, one or more techniques described in U.S. application Ser. No. 18/645,346, filed Apr. 24, 2024, which is incorporated by reference herein in its entirety, are applied for machine learning models used to assist solving of a correspondence algorithm.

FIG. 2B illustrates a flow diagram for a method 218 of determining a depth of an internal structure of a tooth, in accordance with embodiments of the present disclosure. Method 218 may be performed at block 216 of method 200 in some embodiments. At block 219 of method 218, processing logic may estimate the index of refraction of the enamel of the tooth. The index of refraction may be estimated using the techniques set forth herein (e.g., based on knowledge of the angle at which light rays impact a surface of the tooth and a change in direction of the light rays within the enamel of the tooth). In one embodiment, the index of refraction is estimated to be between about 1.5 to 1.7. In one embodiment, a default index of refraction for the tooth enamel is set to 1.5, 1.6 or 1.7.

At block 220 of method 218, processing logic determines a first 3D coordinate of a first point on the surface of a tooth based on an identified surface reflection of an infrared light ray from the surface of the tooth (e.g., as determined at blocks 206 and 214 of method 200). At block 222, processing logic determines a second 3D coordinate of a second point on a surface of an internal structure within the tooth based an identified internal scattering off of the internal structure within the tooth (e.g., as determined at blocks 208 and 214 of method 200. In some embodiments, the estimated index of refraction is used in determining the second point on the surface of the internal structure. At block 224, processing logic determines a distance between the first 3D coordinate and the second 3D coordinate. At block 226, processing logic determines a depth of the internal structure based on the determined distance. For example, processing logic may measure the distance, and the measurement may represent the depth of the internal structure along a particular vector. In embodiments, multiple 3D points on the tooth surface and multiple 3D points on the surface of the internal structure may be determined, and for each given point on the internal structure surface a minimum distance to a point on the 3D tooth surface may be determined. This may indicate the minimum depth of the internal structure in an embodiment. In one embodiment, depth of the internal structure may be determined in a particular axis, which may be selected by a doctor in some embodiments. For example, a depth may be determined by measuring a distance between a point on the internal structure and a point on the tooth surface along a given axis (e.g., a vertical axis, a horizontal axis, etc.). In some embodiments, if the internal structure is a dentin, then the depth of the internal structure may also represent a thickness of an enamel of the tooth.

FIG. 2C illustrates a flow diagram for a method of determining an internal structure of a tooth based on projecting patterned infrared light and projecting patterned visible light, in accordance with embodiments of the present disclosure. At block 232 of method 230, processing logic causes an intraoral scanner to project patterned infrared light comprising a plurality of infrared light rays onto a tooth using a first structure light projector of the intraoral scanner. At block 234, processing logic causes two or more cameras of the intraoral scanner to generate a first set of images of the patterned infrared light projected onto the tooth.

At block 236, processing logic causes the intraoral scanner to project patterned visible light comprising a plurality of visible light rays onto the tooth using the first structured light projector or a second structured light projector of the intraoral scanner. At block 238, processing logic causes two or more cameras of the intraoral scanner to generate a second set of images of the patterned visible light projected onto the tooth.

In embodiments, the operations of blocks 232-234 and 236-238 may be performed alternately. For example, the intraoral scanner may generate two to ten sets of intraoral images using patterned visible light, a set of intraoral images using pattered infrared light, two to ten sets of images using patterned visible light, a set of intraoral images using patterned infrared light, and so on. For each set of images the images of the set may be captured simultaneously or near-simultaneously in embodiments. In some embodiments, the operations of blocks 232-234 and of blocks 236-238 are performed in parallel. For example operations of block 232 and 236 may be performed in parallel, and operations of blocks 234 and 238 may be performed in parallel. For example, patterned infrared light and patterned visible light may be projected at the same time. Cameras may include specialized filters such as a red, green, blue, infrared (RGBIR) filter to capture both visible and infrared light. Traditional red, green, blue (RGB) filters capture light in the visible spectrum (red, green, and blue). An RGBIR filter, on the other hand, includes an additional layer or section that may capture near-infrared (NIR) light, which extends beyond the visible spectrum (typically around 700-1000 nm wavelength). In embodiments, the sensor array of one or more cameras is typically arranged to alternate between RGB and IR pixels or to add an IR channel alongside the RGB channels. This setup captures separate information from visible and infrared spectrums simultaneously.

In some embodiments, separate structured light projectors are used to project the patterned visible light and to project the patterned infrared light. Alternatively, one or more structured light projectors may be configured to project both patterned infrared light and patterned visible light, as shown below with reference to FIGS. 20A-21B. In some embodiments, a single light projector may project multiple wavelengths of visible light (e.g., green light and red light) as well as infrared light.

At block 240, processing logic determines a three-dimensional surface of the tooth using the second set of images and a correspondence algorithm. This may include determining 3D coordinates of intersections of projector rays of a projected patterned visible light and camera rays of cameras capturing the images. In embodiments, intersections of pattern features associated with the projector rays and image features associated with the camera rays are determined. The correspondence algorithm may be solved in the manner as described above with reference to infrared patterned light in embodiments. Once the correspondence algorithm is solved to determine 3D coordinates of points on the tooth surface (and/or other dental site surface), these 3D coordinates may be used to perform registration of intraoral scans together to generate the 3D surface.

At block 242, processing logic determines an internal surface of one or more internal structures within the tooth using the first set of images and the correspondence algorithm. The points captured of the interior of the tooth may show up at distorted positions due, for example, to the index of refraction of the enamel of the tooth and/or the shape of the tooth. However, since the shape of the 3D surface of the tooth is determined at block 240, the known shape of the tooth can be used to compensate for any distortion of the locations of internal points within the tooth that are captured based on the known shape of the 3D surface. The surface of a tooth is curved. The specific curvature of the tooth may be determined for the 3D surface of the tooth. Additionally, the angle and position of infrared light rays is known relative to the tooth. Accordingly, the angle at which the light rays hit the tooth may be determined. Additionally, an amount of change in direction of the infrared light rays after entering the enamel of the tooth may be determined. Based on the measured change in direction (measured as an angle between the original direction and new direction), and the angle at which the light ray interfaced the tooth, the index of refraction of the enamel may be computed using the Fresnel equations. In some embodiments, an assumption is made that the enamel of the tooth has a uniform index of refraction. In some embodiments, an average index of refraction is computed based on determining index of refraction using multiple infrared light rays and then averaging the results. Accordingly, the angle of the surface of the tooth through which scattered/reflected light rays are observed and the index of refraction of the tooth may be determined, and this information may be used to compensate for any offset in position of points within the tooth that are captured. Additionally, in some embodiments the index(s) of refraction of the enamel of the tooth may be determined based on observed changes in direction of infrared light rays within the tooth, and this information may be used to perform further compensation of locations of captured points within the tooth.

In some embodiments, inverse rendering is implemented as an inverse rendering optimization to determine properties such as index of refraction (of enamel and/or dentin), depth and shape of dentin (e.g., a surface shape of the dentin), and so on. Processing logic may initialize a forward image-formation model using known scene parameters including the reconstructed 3D surface geometry from block 240, calibrated camera intrinsics and extrinsics (e.g., camera position(s)), calibrated laser or structured-light projector poses and beam directions, and/or initial estimates of optical parameters such as one or more indices of refraction of enamel and dentin and candidate depths and shapes of internal structures such as dentin. Using these parameters, a renderer may simulate one or more image(s) expected to be captured by the cameras for the projected pattern. A cost function may then be defined to quantify the discrepancy between the simulated output and the measured data. In some embodiments, the cost is the sum of squared differences between corresponding pixel intensities over one or more images. In other embodiments, the cost is defined over geometric features extracted from the images, such as the pixel locations of projected pattern lines, laser spots on the external surface, and observed intersections or loci where rays interact with internal structures (e.g., dentin), and the objective penalizes the Euclidean displacement between simulated and measured feature locations. Processing logic may iteratively update the unknown parameters, which may include per-material index of refraction values, internal surface depth or shape parameters, and/or variables such as projector intensity scale, to minimize the cost subject to physical constraints. In some embodiments, gradients are obtained analytically or via automatic differentiation through the renderer; in other embodiments, derivative-free search is used. The optimization may be performed jointly across multiple synchronized or near-synchronized views and time-adjacent frames so that shared parameters, such as an index of refraction, are consistently estimated by minimizing a single cost accumulated over some or all relevant images. Upon convergence to a minimum, the estimated parameters may be used to compensate the apparent positions of internal points by refracting rays at the known 3D surface according to the recovered indices of refraction and by updating the internal surface model, thereby yielding corrected 3D locations of internal structures. Rendering through transparent and translucent dental tissues is known to be challenging; however, constraining the problem with the known external 3D surface, calibrated sensor geometry, and structured-light patterns enables a practicable inverse solution.

Accordingly, in some embodiments processing logic uses inverse rendering to iteratively modify parameters in a way that minimizes the difference between the captured image and a rendered image, until a minimum difference is reached. The parameters associated with the minimum difference may then be used to estimate depth position of one or more interior features of a tooth (e.g., dentin) and/or an index of refraction. In some embodiments, processing logic may determine parameters that minimize a difference between the captured image and a rendered image across multiple views of the same region, where the multiple views may be from the same and/or different cameras. In an example, say in one image a pixel location of a ray hitting the dentin is at pixel (100, 100), and in the rendered image the location is (110, 95). In this case the error would be (10,5). This error can be accumulated across other rays and images and a mean square error may be minimized.

In some embodiments, instead of rendering the image, processing logic extracts geometric information from the images. The geometric information may include where the line of a ray is passing, where a pattern feature (e.g., spot) hits a surface, where in the image the ray is seen to hit the internal dentin, and so on. The minimization process may be performed using such information to minimize the difference between these values (e.g., pixel locations) versus the values extracted from the captured images. In some embodiments, a rendered image is generated and compared to a captured image. In some embodiments, a rendered image is not generated, and instead image locations are calculated and used to compare to image locations in the captured image without actually rendering an image using the scene parameters.

Additionally, processing logic may register the intraoral scans generated using a projected infrared light pattern to the 3D surface generated using projected visible light pattern(s). For example, 3D points of the surface of the tooth may be determined using the infrared light in addition to 3D points of the interior of the tooth. The 3D points of the surface of the tooth from the infrared light may used to register the intraoral scans generated using infrared light to the intraoral scans generated using visible light. In embodiments where the infrared light and visible light are projected and captured at the same time, each intraoral scan may include some 3D points of the interior of the tooth generated from the infrared light and many 3D points of the surface of the tooth generated from the infrared light and from the visible light.

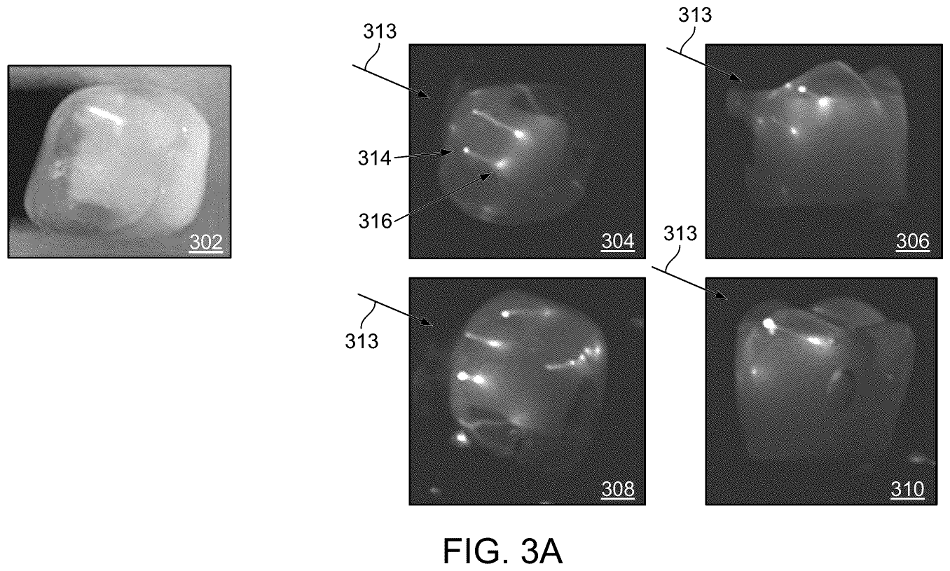

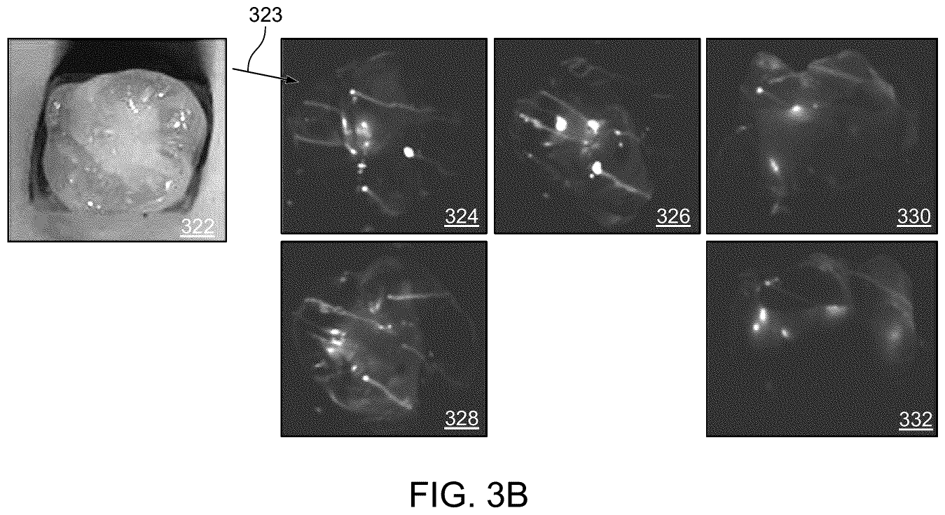

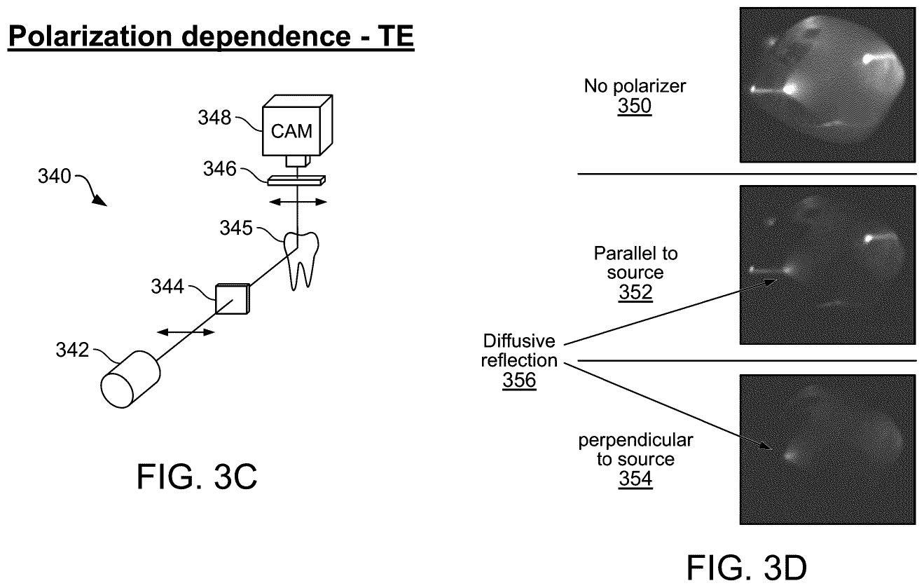

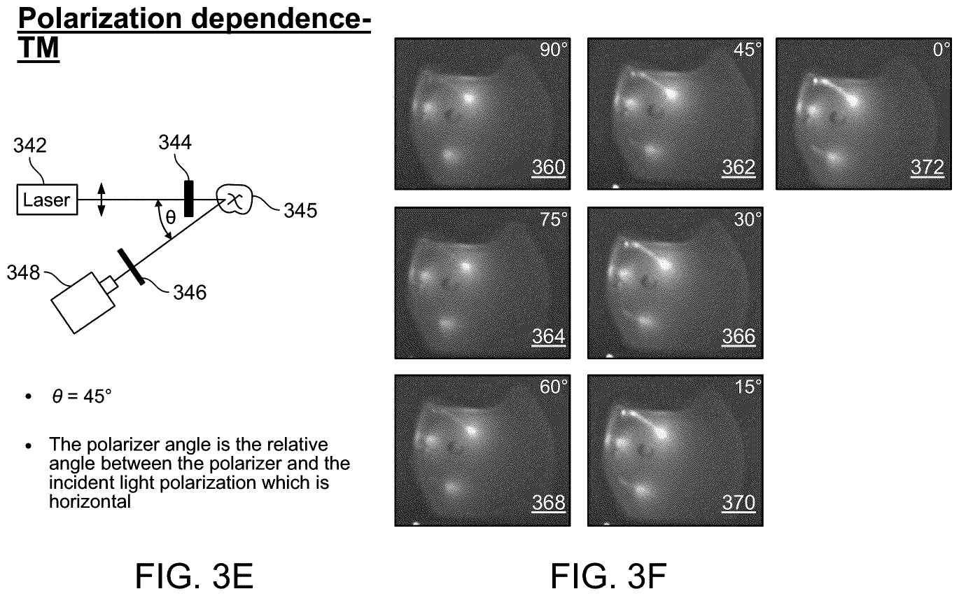

FIG. 3A illustrates examples of infrared light rays travelling through a physical model of a tooth, in accordance with embodiments of the present disclosure. Similar effects as those shown in FIG. 3A with respect to the physical model of the tooth also occur in a real tooth, but with increased irregularity in some instances. A first image 302 was captured using visible light. A second image 304, third image 306, fourth image 308 and fifth image 310 were each captured using structured infrared light projected onto the tooth along an incident vector 313. Images 304 and 308 show an occlusal surface of the tooth, and images 306 and 310 show a buccal surface of the tooth. In image 304, a first point 314 is captured at the location where an infrared light ray impacted the tooth (e.g., due to external surface reflection and/or scattering), and a second point 316 is captured at the location where the infrared light ray impacted the dentin of the tooth (e.g., due to scattering). A line within the enamel is also captured between the first point 314 and the second point 316 (e.g., due to a small amount of scattering). As shown, the first point 314 is relatively bright and has defined edges. As the infrared light ray travels through the tooth, the light ray gets progressively dimmer in embodiments. The second point 316 is dimmer and has less well defined edges (e.g., due to scattering of the light when it interfaces with the dentin). Similar phenomena can be observed in images 306-310.

FIG. 3B illustrates further examples of infrared light rays travelling through a physical model of a tooth, in accordance with embodiments of the present disclosure. Similar effects as those shown in FIG. 3B with respect to the physical model of the tooth also occur in a real tooth, but with increased irregularity in some instances. A first image 322 was captured using visible light. A second image 324, third image 326, fourth image 328, fifth image 330 and sixth image 332 were each captured using structured infrared light projected onto the tooth along an incident vector 323. Images 324, 326 and 328 show an occlusal surface of the tooth, and images 330 and 332 show a buccal surface of the tooth. Each image shows at least a first point captured at the location where an infrared light ray impacted the tooth, and a second point at the location where the infrared light ray impacted the dentin of the tooth. A line within the enamel is also captured between the first point and the second point. As shown, the infrared light rays within a tooth may not appear as straight lines. This may be due to distortions caused by viewing the infrared light ray's path from outside the tooth (e.g., curvature may be introduced due to the 3D shape of the tooth through which the path of the infrared light ray is viewed and/or due to a differing index of refraction at different regions of the enamel of the tooth through which the infrared light ray travels.

FIG. 3C illustrates an infrared laser and camera of an intraoral scanner positioned relative to a scanned tooth, in accordance with embodiments of the present disclosure. Infrared light rays of a structured infrared light pattern may be polarized. As the infrared light rays reflect and/or scatter off of surfaces, the infrared light rays may lose some fraction of their polarization. This phenomenon may be used to better image projected infrared light rays in some embodiments.

As shown, a laser 342 may project infrared light that is linearly polarized in a first axis (e.g., a horizontal axis perpendicular to the direction of the light rays in the illustration). A multi-lens array, diffractive grating, or other optical element 344 may split a coherent infrared light beam projected by laser 342 into a structured pattern of infrared light rays. The structured pattern of infrared light rays may be incident on a tooth 345. A camera 348 may be directed toward the tooth, and may be at an angle relative to the projection direction of the laser 342. In the illustrated embodiment, the camera 348 is angled 90 degrees relative to the laser 342. A linear polarization filter 346 may be disposed in front of the camera 348 such that patterned infrared light reflecting and/or scattering from the tooth 345 is observed by the camera 348 after the light has passed through the linear polarization filter 346. As shown, the linear polarization filter 346 has a same direction of polarization as the polarization of the infrared light beams (parallel to light source). However, The linear polarization filter 346 may also have other polarization orientations.

FIG. 3D illustrates effects of polarization on detection of infrared light rays projected through a physical model of a tooth, in accordance with embodiments of the present disclosure. Similar effects as those shown in FIG. 3D with respect to the physical model of the tooth also occur in a real tooth, but with increased irregularity in some instances. As shown in FIG. 3D, the angle or direction of polarization applied by a linear polarizer placed in front of a camera relative to the polarization of projected infrared light rays may cause different aspects of projected infrared light rays to become more or less visible in captured images. Image 350 shows a captured image of an infrared light ray passing through a tooth without any polarization filter. Image 352 shows a captured image of an infrared light ray passing through a tooth with a linear polarization filter having a polarization direction that is parallel to the polarization direction applied by the infrared light source. Image 354 shows a captured image of an infrared light ray passing through a tooth with a linear polarization filter having a polarization direction that is perpendicular to the polarization direction applied by the infrared light source. As shown, diffuse reflection 356 is captured when polarization filters are applied. The intensity of the captured light ray passing through the tooth is reduced by a first amount when the polarization filter has a polarization that is parallel to the source polarization, and by a greater second amount when the polarization filter as a polarization that is perpendicular to the source polarization.

FIG. 3E illustrates an infrared laser and camera of an intraoral scanner positioned relative to a scanned tooth, in accordance with embodiments of the present disclosure. Infrared light rays of a structured infrared light pattern may be polarized. As the infrared light rays reflect and/or scatter off of surfaces, the infrared light rays may lose some fraction of their polarization. The amount of reduction in the intensity may be at least partially dependent on the angle between the camera (and a polarization filter in front of the camera) and the light source (e.g., laser) in some embodiments. This phenomenon may be used to better image projected infrared light rays in some embodiments.

As shown, a laser 342 may project infrared light that is linearly polarized in a first axis (e.g., a horizontal axis perpendicular to the direction of the light rays in the illustration). A multi-lens array, diffractive grating, or other optical element 344 may split a coherent infrared light beam projected by laser 348 into a structured pattern of infrared light rays. The structured pattern of infrared light rays may be incident on a tooth 345. A camera 348 may be directed toward the tooth, and may be at an angle relative to the projection direction of the laser 342. In the illustrated embodiment, the camera 348 is at some angle theta that is less than 90 degrees relative to the laser 342. A linear polarization filter 346 may be disposed in front of the camera 348 such that patterned infrared light reflecting and/or scattering from the tooth 345 is observed by the camera 348 after the light has passed through the linear polarization filter 346.

FIG. 3F illustrates effects of polarization on detection of infrared light rays projected through a physical model of a tooth, in accordance with embodiments of the present disclosure. Similar effects as those shown in FIG. 3F with respect to the physical model of the tooth also occur in a real tooth, but with increased irregularity in some instances. As shown in FIG. 3F, the angle of a linear polarizer placed in front of a camera relative to the polarization of projected infrared light rays may cause different aspects of projected infrared light rays to become more or less visible in captured images. Image 360 shows a captured image of an infrared light ray passing through a tooth for a polarizer angle that is 90 degrees relative to the direction of the laser 342. Image 362 shows a captured image of an infrared light ray passing through a tooth for a polarizer angle that is 45 degrees relative to the direction of the laser 342. Image 360 shows a captured image of an infrared light ray passing through a tooth for a polarizer angle that is 0 degrees relative to the direction of the laser 342. Image 360 shows a captured image of an infrared light ray passing through a tooth for a polarizer angle that is 75 degrees relative to the direction of the laser 342. Image 360 shows a captured image of an infrared light ray passing through a tooth for a polarizer angle that is 30 degrees relative to the direction of the laser 342. Image 360 shows a captured image of an infrared light ray passing through a tooth for a polarizer angle that is 60 degrees relative to the direction of the laser 342. Image 360 shows a captured image of an infrared light ray passing through a tooth for a polarizer angle that is 15 degrees relative to the direction of the laser 342.

In some cases, polarization filter 346 can be used to enhance the clarity of captured images of patterned infrared light rays projected onto a tooth. Single scattered light will keep some of its polarization, but multiple scattering will lose all its polarization. By judicious use of polarization, the multiple scattering that is captured may be reduced so that contrast will improve (e.g., the polarization filter will remove just half of this light).

FIG. 4 illustrates one embodiment of a system 400 for performing intraoral scanning and/or generating a virtual 3D model of a dental arch. In one embodiment, system 400 carries out one or more operations of above described methods 200, 218 and/or 230. System 400 includes a computing device 405 that may be coupled to an intraoral scanner 450 (also referred to simply as a scanner 450) and/or a data store 410.

Computing device 405 may include a processing device, memory, secondary storage, one or more input devices (e.g., such as a keyboard, mouse, tablet, and so on), one or more output devices (e.g., a display, a printer, etc.), and/or other hardware components. Computing device 405 may be connected to a data store 410 either directly or via a network. The network may be a local area network (LAN), a public wide area network (WAN) (e.g., the Internet), a private WAN (e.g., an intranet), or a combination thereof. The computing device and the memory device may be integrated into the scanner in some embodiments to improve performance and mobility.

Data store 410 may be an internal data store, or an external data store that is connected to computing device 405 directly or via a network. Examples of network data stores include a storage area network (SAN), a network attached storage (NAS), and a storage service provided by a cloud computing service provider. Data store 410 may include a file system, a database, or other data storage arrangement.

In some embodiments, a scanner 450 for obtaining three-dimensional (3D) data of a dental site in a patient's oral cavity is also operatively connected to the computing device 405. Scanner 450 may include a probe (e.g., a hand held probe) for optically capturing three dimensional structures.

In some embodiments, the scanner 450 includes an elongate wand including a probe at a distal end of the wand, a rigid structure disposed within a distal end of the probe, one or more structured light projectors coupled to the rigid structure that project structured light in the visible spectrum, one or more structured light projectors coupled to the rigid structure that project structured light in the infrared or near-infrared spectrum, and optionally one or more non-structured light projectors coupled to the rigid structure, such as non-coherent light projectors. The scanner 450 further includes one or more cameras coupled to the rigid structure. In some applications, each light projector may have an AFOI of 45-120 degrees. Optionally, the one or more light projectors that project visible light and the one or more light projectors that project infrared light may utilize a laser diode light source. Further, the structured light projector(s) that project visible light and the structured light projector(s) that project infrared light may include a beam shaping optical element. Further still, the structured light projector(s) that project visible light and the structured light projector(s) that project infrared light may include a pattern generating optical element.

One or more pattern generating optical elements may be configured to generate a light pattern such as a distribution of discrete unconnected spots of light. One or more pattern generating optical elements may be configured to generate a light pattern such as a checkerboard pattern, a grid pattern, a line pattern, and so on. In some embodiments, the light patterns are static (e.g., unchanging) light patterns. In some embodiments, the light patterns are non-coded light patterns. In some embodiments, output patterned infrared light and patterned visible light have a same pattern. The light pattern(s) may be generated at all planes located between specific distances (e.g., 0-30 mm, 0-20 mm etc.) from the pattern generating optical element when the light source (e.g., laser diode) is activated to transmit light through the pattern generating optical element. In some applications, the pattern generating optical element utilizes diffraction and/or refraction to generate the distribution of pattern features (e.g., of spots). Optionally, the pattern generating optical element has a light throughput efficiency of at least 90%.

For some applications, the light projectors and the cameras are positioned such that each light projector faces an object outside of the wand placed in its field of illumination. Optionally, each camera may face an object outside of the wand placed in its field of view. Additionally, or alternatively, one or more light projectors and/or cameras may face a mirror that reflects light to/from an object being scanned. Further, in some applications, at least 20% of the pattern features are in the field of view of at least one of the cameras.

The scanner 450 may be used to perform intraoral scanning of a patient's oral cavity. A result of the intraoral scanning may be a sequence of intraoral scans generated using visible light and a sequence of intraoral scans generated using infrared light. An operator may start recording one or both sequences of intraoral scans with the scanner 450 at a first position in the oral cavity, move the scanner 450 within the oral cavity to a second position while automatically capturing scans, and then stop capturing scans upon receiving an instruction to stop capturing scans or satisfying some criterion. The scanner 450 may transmit the intraoral scans generated using visible light (referred to as visible light scan data 435) and the intraoral scans generated using infrared light (referred to as infrared scan data 436) to the computing device 405. Additionally, two-dimensional (2D) color image data 437 may also be captured by the scanner 450 and stored in data store 410 in embodiments. Note that in some embodiments the computing device may be integrated into the scanner 450. Computing device 405 may store the visible light scan data 435, infrared scan data 436 and 2D color image data 437 in data store 410. Alternatively, scanner 450 may be connected to another system that stores the scan data 435, scan data 436 and/or 2D color image data 437 in data store 410. In such an embodiment, scanner 450 may not be connected to computing device 405.

Scanner 450 may drive each one of one or more visible light structured light projectors and infrared structured light projectors to alternately or at the same time project a light pattern (e.g., a distribution of discrete unconnected spots of light, a checkerboard pattern, etc.) on an intraoral three-dimensional surface (e.g., a tooth). Scanner 450 may further drive each one of one or more cameras to capture an image, the image including one or more image features corresponding to pattern features projected by one of the light projectors of the scanner 450. Each one of the one or more cameras may include a camera sensor including an array of pixels. The images captured together at a particular time may together form an intraoral scan (e.g., an infrared intraoral scan if patterned infrared light is projected or a standard intraoral scan if patterned visible light is projected). The intraoral scans may be transmitted to computing device 405 and/or stored in data store 410.

Computing device 405 may include an intraoral scanning module 408 for facilitating intraoral scanning and generating 3D models of dental arches from intraoral scans. Intraoral scanning module 408 may include a surface detection module 415, an internal tooth structure detection module 416 and a model generation module 425 in some embodiments. Surface detection module 415 may analyze received image data 435 to identify objects in the intraoral scans of the image data 435 using patterned visible light. Surface detection module 415 may process images to detect pattern features captured in the images. In some embodiments, intraoral images are processed using traditional image processing techniques to identify known pattern features in the images. In some embodiments, intraoral images are processed using a trained machine learning model (e.g., a deep neural net), which may output coordinates of each detected pattern feature (e.g., of each detected spot). Internal tooth structure detection module 416 may perform similar functions as surface detection module 415, but may do so based on images of infrared light rays projected through a tooth. Internal tooth structure detection module 416 may detect different types of infrared light interactions with a tooth, such as reflection/scattering from a tooth surface, a light ray path through a tooth enamel, an abrupt change in direction of an infrared light ray in a tooth enamel, scattering of an infrared light ray caused by contact with dentin and/or caries, and so on. In embodiments, internal tooth structure detection module 416 may identify captured pattern features of a projected infrared light pattern interfacing with multiple different internal structures within a tooth. In some embodiments, internal tooth structure detection module 416 uses traditional image processing techniques to identify particular interactions of infrared light rays with different surfaces on or in a tooth. In some embodiments, internal tooth structure detection module 416 uses one or more trained machine learning models to identify particular interactions of infrared light rays with different surfaces on or in a tooth.

Surface detection module 415 and internal tooth structure detection module 416 may each execute a correspondence algorithm on respective intraoral scans to determine the depths of spots, points, and/or other pattern features in the intraoral scans. The surface detection module 415 and internal tooth structure detection module 416 may access stored calibration data 430 indicating (a) a camera ray of an image feature corresponding to each pixel on the camera sensor of each one of the one or more cameras, and (b) a projector ray corresponding to each of the projected pattern features from each one of the one or more projectors, where each projector ray corresponds to a respective path of pixels on at least one of the camera sensors. Using the calibration data 430 and the correspondence algorithm, surface detection module 415 and internal tooth structure detection module 416 may, (1) for each projector ray i, identify for each detected image feature j on a camera sensor path corresponding to ray i, how many other cameras, on their respective camera sensor paths corresponding to ray i, detected respective image features k corresponding to respective camera rays that intersect ray i and the camera ray corresponding to detected image feature j. Ray i is identified as the specific projector ray that produced a detected image feature j for which the highest number of other cameras detected respective image features k. Surface detection module 415 may further (2) compute a respective three-dimensional position on an intraoral three-dimensional surface at the intersection of projector ray i and the respective camera rays corresponding to the detected image feature j and the respective detected image features k. For some applications, running the correspondence algorithm further includes, following operation (1), optionally removing from consideration projector ray i (e.g., in the case of a patterned visible light), and the respective camera rays corresponding to the detected image feature j and the respective detected image features k, and running the correspondence algorithm again for a next projector ray i and/or for a same projector ray i that might have further intersections with other internal structures of the tooth (e.g., in the case of patterned infrared light projection).

Model generation module 425 may perform registration between intraoral scans generated using patterned visible light and/or between intraoral scans generated using patterned infrared light (e.g., may stitch together the intraoral scans as discussed above). Model generation module 425 may then generate a virtual 3D model of a dental arch and teeth of the dental arch from the registered intraoral scans, where the virtual 3D model may include 3D surface information of internal structures within the teeth determined from the patterned infrared light, as discussed above.

In some embodiments, intraoral scanning module 408 includes a user interface module 409 that provides a user interface that may display the generated virtual 3D model. In embodiments, the exterior surface of teeth and the surface of internal structures within the teeth (e.g., of dentin, caries, cracks, etc.) may be shown in the 3D model. In embodiments, the relative transparencies of the external surface and of one or more internal surfaces (e.g., of a dentin) may be adjusted. For example, a doctor may select to view the internal structures, and the external surface transparency may be adjusted to 50-100% to show the internal structures. In another example, the doctor may select to view only external structures, which may cause the transparency of the external surface to become 0%.

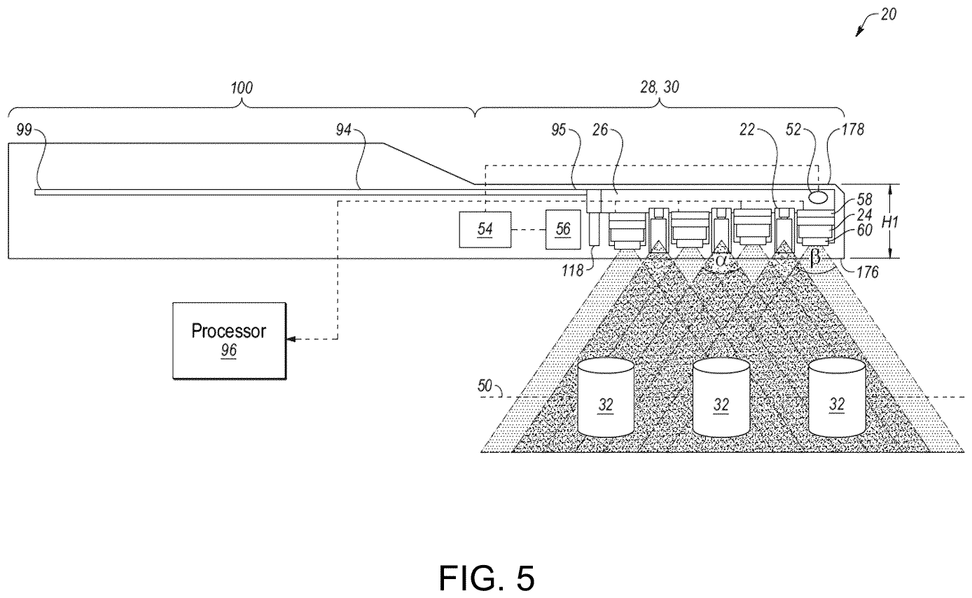

Reference is now made to FIG. 5, which is a schematic illustration of an elongate wand 20 for intraoral scanning, in accordance with some applications of the present disclosure. A plurality of light projectors 22 (e.g., including structured light projectors that project visible light, structured light projectors that project infrared light, and/or unstructured light projectors) and a plurality of cameras 24 are coupled to a rigid structure 26 disposed within a probe 28 at a distal end 30 of the wand. In some applications, during an intraoral scan, probe 28 enters the oral cavity of a subject.

For some applications, light projectors 22 are positioned within probe 28 such that one or more light projector 22 faces a 3D surface 32A and/or a 3D surface 32B outside of wand 20 that is placed in its field of illumination, as opposed to positioning the light projectors in a proximal end of the wand and illuminating the 3D surface by reflection of light off a mirror and subsequently onto the 3D surface. Similarly, for some applications, cameras 24 are positioned within probe 28 such that each camera 24 faces a 3D surface 32A, 32B outside of wand 20 that is placed in its field of view, as opposed to positioning the cameras in a proximal end of the wand and viewing the 3D surface by reflection of light off a mirror and into the camera. This positioning of the projectors and the cameras within probe 28 enables the scanner to have an overall large field of view while maintaining a low profile probe.

In some applications, a height H1 of probe 28 is less than 15 mm, height H1 of probe 28 being measured from a lower surface 176 (sensing surface), through which reflected light from 3D surface 32A, 32B being scanned enters probe 28, to an upper surface 178 opposite lower surface 176. In some applications, the height H1 is between 10-15 mm.

In embodiments, the light projectors and cameras disposed at a distal end of an intraoral scanner are non-telecentric. A camera may have a predefined field of view (FOV) and/or a predefined angular field of view (AFOV). Similarly, a light projector may have a predefined field of illumination (FOI) and/or a predefined angular field of illumination (AFOI). The field of view (FOV) of a camera in the intraoral scanner may be understood as the extent of the observable world that is seen at any given moment by the camera. The FOV may be reported as an area measure, e.g. an area at a given distance from the camera or at a given distance below the probe of the intraoral scanner. The angular field of view (AFOV) is correlated to the FOV, and the AFOI is correlated to the FOI. However, herein the AFOV and AFOI are expressed as angles and the FOV and FOI are expressed as an area. In embodiments, the light projectors have an AFOI that cause the FOI of the light projectors to become larger with increased distance from the intraoral scanner. Additionally or alternatively, the cameras have an AFOV that cause the FOV of the cameras to become larger with increased distance/depth from the intraoral scanner. The AFOI of the light projectors may cause light patterns projected by the respective light projectors to have different amounts of interference and/or overlap at different depths. Depth as used in this context may refer to a distance between intraoral scanner (e.g., the light projector and/or camera of the intraoral scanner) and an imaged surface along an imaging axis that is orthogonal to a longitudinal axis of the intraoral scanner (e.g., to a longitudinal axis of a probe of the intraoral scanner that contains the cameras and light projectors).

Each camera may be configured to capture a plurality of images that depict at least a portion of the projected pattern(s) of light as projected by the multiple light projectors on an intraoral object. In some applications, the light projectors may have an AFOI of at least 45 degrees. Optionally, the AFOI may be less than 120 degrees. For structured light projectors, each of the structured light projectors (e.g., visible and/or infrared structured light projectors) may further include a pattern generating optical element. The pattern generating optical element may utilize diffraction and/or refraction to generate a light pattern (e.g., where coherent light is used). Alternatively, the pattern generating optical element may be a mask that blocks a portion of the light and passes a remainder of the light. The mask can be a static mask or a changing mask such as a digital micro-mirror (DMD), a display, etc. In some applications, one or more of the light pattern(s) may be a distribution of discrete unconnected spots of light. In some applications, at least one light pattern may be a checkerboard pattern. Other light patterns such as grids, lines, regular distributions of polygons, etc. may additionally or alternatively be used. Optionally, the light pattern maintains the distribution of discrete unconnected spots or other pattern features at all planes located up to a threshold distance (e.g., 30 mm, 40 mm, 60 mm, etc.) from the pattern generating optical element, when the light source (e.g., laser diode) is activated to transmit light through the pattern generating optical element. Each of the cameras includes a camera sensor and objective optics including one or more lenses.

In some applications, the AFOV of each of the cameras may be at least 45 degrees, e.g., at least 80 degrees, e.g., 85 degrees. Optionally, the AFOV of each of the cameras may be less than 120 degrees, e.g., less than 90 degrees. The fields of view of the various cameras may together form a field of view of the intraoral scanner. In any case, the fields of view and/or angular fields of view of the various cameras may be identical or non-identical. Similarly, the focal length of the various cameras may be identical or non-identical. Further, each camera may be configured to focus at an object focal plane that is located up to a threshold distance from the respective camera sensor (e.g., up to a distance of 10 mm, 20 mm, 30 mm, 40 mm, 50 mm, 60 mm, 70 mm, 80 mm, etc. from the respective camera sensor). As distances increase, the accuracy of the position of the detected surfaces decreases. In one embodiment, beyond the threshold distance the accuracy is below an accuracy threshold. Similarly, in some applications, the AFOI of each of the light projectors (e.g., structured light projectors and/or non-structured light projectors) may be at least 45 degrees and optionally less than 120 degrees. A large field of view (FOV) of the intraoral scanner achieved by combining the respective fields of view of all the cameras may improve accuracy (as compared to traditional scanners that typically have a FOV of 10-20 mm in the x-axis and γ-axis and a depth of capture of about 0-15 or 025 mm) due to reduced amount of image stitching errors, especially in edentulous regions, where the gum surface is smooth and there may be fewer clear high resolution 3-D features. Having a larger FOV for the intraoral scanner enables large smooth features, such as the overall curve of the tooth, to appear in each image frame, which improves the accuracy of stitching respective surfaces obtained from multiple such image frames.

In some applications, the total combined FOV of the various cameras (e.g., of the intraoral scanner) is between about 20 mm and about 50 mm along the longitudinal axis of the elongate wand, and about 20-60 mm (or 20-40 mm) in the z-axis, where the z-axis may correspond to depth. In further applications, the field of view may be about 20 mm, about 25 mm, about 30 mm, about 35 mm, or about 40 mm along the longitudinal axis and/or at least 20 mm, at least 25 mm, at least 30 mm, at least 35 mm, at least 40 mm, at least 45 mm, at least 50 mm, at least 55 mm, at least 60 mm, at least 65 mm, at least 70 mm, at least 75 mm, or at least 80 mm in the z-axis. In some embodiments, the combined field of view may change with depth (e.g., with scanning distance). For example, at a scanning distance of about 4 mm the field of view may be about 20 mm along the longitudinal axis, and at a scanning distance of about 20-50 mm the field of view may be about 30 mm or less along the longitudinal axis. If most of the motion of the intraoral scanner is done relative to the long axis (e.g., longitudinal axis) of the scanner, then overlap between scans can be substantial. In some applications, the field of view of the combined cameras is not continuous. For example, the intraoral scanner may have a first field of view separated from a second field of view by a fixed separation. The fixed separation may be, for example, along the longitudinal axis of the elongate wand.

In some embodiments, the large FOV of the intraoral scanner increases an accuracy of the detected depth of 3D surfaces. For example, the accuracy of a depth measurement of a detected 3D surface may be based on the longitudinal distance between two cameras or between a light projector and a camera, which may represent a triangulation baseline distance. In embodiments, cameras and/or light projectors may be spaced apart in a configuration that provides for increased accuracy of depth measurements for 3D surfaces that, for example, have a depth of up to 30 mm, up to 40 mm, 15-25 mm, and so on.

In some applications, cameras 24 each have a large AFOV β (beta) of at least 45 degrees, e.g., at least 70 degrees, e.g., at least 80 degrees, e.g., 85 degrees. In some applications, the field of view may be less than 120 degrees, e.g., less than 100 degrees, e.g., less than 90 degrees. In experiments performed by the inventors, AFOV β (beta) for each camera being between 80 and 90 degrees was found to be particularly useful because it provided a good balance among pixel size, field of view and camera overlap, optical quality, and cost. Cameras 24 may include a camera sensor 58 and objective optics 60 including one or more lenses. To enable close focus imaging cameras 24 may focus at an object focal plane 50 that is located between 1 mm and 30 mm, e.g., between 4 mm and 24 mm, e.g., between 5 mm and 11 mm, e.g., 9 mm-10 mm, from the lens that is farthest from the camera sensor. Cameras 24 may also detect 3D surfaces located at greater distances from the camera sensor, such as 3D surfaces at 40 mm, 50 mm, 60 mm, 70 mm, 80 mm, 90 mm, and so on from the camera sensor.

As described hereinabove, a large field of view achieved by combining the respective fields of view of all the cameras may improve accuracy due to reduced amount of image stitching errors, especially in edentulous regions, where the gum surface is smooth and there may be fewer clear high resolution 3-D features. Having a larger field of view enables large smooth features, such as the overall curve of the tooth, to appear in each image frame, which improves the accuracy of stitching respective surfaces obtained from multiple such image frames.

Similarly, light projectors 22 may each have a large AFOI α (alpha) of at least 45 degrees, e.g., at least 70 degrees. In some applications, AFOI α (alpha) may be less than 120 degrees, e.g., than 100 degrees.

For some applications, in order to improve image capture, each camera 24 has a plurality of discrete preset focus positions, in each focus position the camera focusing at a respective object focal plane 50. Each of cameras 24 may include an autofocus actuator that selects a focus position from the discrete preset focus positions in order to improve a given image capture. Additionally or alternatively, each camera 24 includes an optical aperture phase mask that extends a depth of focus of the camera, such that images formed by each camera are maintained focused over all 3D surface distances located between 1 mm and 30 mm, e.g., between 4 mm and 24 mm, e.g., between 5 mm and 11 mm, e.g., 9 mm-10 mm, from the lens that is farthest from the camera sensor. In further embodiments, images formed by one or more cameras may additionally be maintained focused over greater 3D surface distances, such as distances up to 40 mm, up to 50 mm, up to 60 mm, up to 70 mm, up to 80 mm, or up to 90 mm.

In some applications, light projectors 22 and cameras 24 are coupled to rigid structure 26 in a closely packed and/or alternating fashion, such that (a) a substantial part of each camera's field of view overlaps the field of view of neighboring cameras, and (b) a substantial part of each camera's field of view overlaps the field of illumination of neighboring projectors. Optionally, at least 20%, e.g., at least 50%, e.g., at least 75% of the projected pattern of light are in the field of view of at least one of the cameras at an object focal plane 50 that is located at least 4 mm from the lens that is farthest from the camera sensor. Due to different possible configurations of the projectors and cameras, some of the projected pattern may never be seen in the field of view of any of the cameras, and some of the projected pattern may be blocked from view by 3D surface 32A, 32B as the scanner is moved around during a scan.

Rigid structure 26 may be a non-flexible structure to which light projectors 22 and cameras 24 are coupled so as to provide structural stability to the optics within probe 28. Coupling all the projectors and all the cameras to a common rigid structure helps maintain geometric integrity of the optics of each light projector 22 and each camera 24 under varying ambient conditions, e.g., under mechanical stress as may be induced by the subject's mouth. Additionally, rigid structure 26 helps maintain stable structural integrity and positioning of light projectors 22 and cameras 24 with respect to each other. As further described hereinbelow, controlling the temperature of rigid structure 26 may help enable maintaining geometrical integrity of the optics through a large range of ambient temperatures as probe 28 enters and exits a subject's oral cavity or as the subject breathes during a scan.

As shown, 3D surface 32A and 3D surface 32B are in a FOV of the probe 28, with 3D surface 32A being relatively close to the probe 28 and 3D surface 32B being relatively far from the probe 28.

Whether a pair of cameras or a pair of a camera and a light projector are used, the accuracy of the triangulation used to determine the depth of 3D surfaces may be roughly estimated by the following equation:

$${z}_{e r r} = \frac{{p}_{e r r} \cdot {z}^{2}}{f \cdot b}$$

Where zₑᵣᵣ is the error in the depth, pₑᵣᵣ is the basic image processing error (generally a sub-pixel error), z is the depth, f is the focal length of the lens, and b is the base line (the distance between two cameras when using stereo imaging or the distance between the camera and the light projector when using structured light). In embodiments, the probe of the intraoral scanner is configured such that the maximum baseline between two cameras or between a camera and a light projector is large and provides a high level of accuracy for triangulation.

In some embodiments, intraoral scanner 20 corresponds to the intraoral scanner of U.S. Pat. No. 11,896,461, issued Feb. 13, 2024, which is incorporated by reference herein, with the addition of structured light projectors that projected patterned infrared light and processors capable of processing images captured of the patterned infrared light projected onto teeth to determine information about the internal structure of the teeth.

Reference is now made to FIG. 6, which is a chart depicting a plurality of different configurations for the position of light projectors 22 and cameras 24 in probe 28, in accordance with some applications of the present disclosure. Light projectors 22 are represented in FIG. 6 by circles and cameras 24 are represented in FIG. 6 by rectangles. Light projectors may be infrared light projectors, visible light projectors, or a combination thereof. It is noted that rectangles are used to represent the cameras, since typically, each camera sensor 58 and the AFOV β (beta) of each camera 24 have aspect ratios of 1:2. Column (a) of FIG. 6 shows a bird's eye view of the various configurations of light projectors 22 and cameras 24. The x-axis as labeled in the first row of column (a) corresponds to a central longitudinal axis of probe 28. Column (b) shows a side view of cameras 24 from the various configurations as viewed from a line of sight that is coaxial with the central longitudinal axis of probe 28. Column (b) of FIG. 6 shows cameras 24 positioned so as to have optical axes 46 at an angle of 90 degrees or less, e.g., 35 degrees or less, with respect to each other. Column (c) shows a side view of cameras 24 of the various configurations as viewed from a line of sight that is perpendicular to the central longitudinal axis of probe 28.

In one embodiment, the distal-most (toward the positive x-direction in FIG. 6) and proximal-most (toward the negative x-direction in FIG. 6) cameras 24 are positioned such that their optical axes 46 are slightly turned inwards, e.g., at an angle of 90 degrees or less, e.g., 35 degrees or less, with respect to the next closest camera 24. The camera(s) 24 that are more centrally positioned, i.e., not the distal-most camera 24 nor proximal-most camera 24, are positioned so as to face directly out of the probe, their optical axes 46 being substantially perpendicular to the central longitudinal axis of probe 28. It is noted that in row (xi) a projector 22 is positioned in the distal-most position of probe 28, and as such the optical axis 48 of that projector 22 points inwards, allowing a larger number of spots 33 projected from that particular projector 22 to be seen by more cameras 24.

In one embodiment, the number of light projectors 22 in probe 28 may range from two, e.g., as shown in row (iv) of FIG. 6, to six, e.g., as shown in row (xii). In one embodiment, the number of cameras 24 in probe 28 may range from four, e.g., as shown in rows (iv) and (v), to seven, e.g., as shown in row (ix) or eight. It is noted that the various configurations shown in FIG. 6 are by way of example and not limitation, and that the scope of the present disclosure includes additional configurations not shown. For example, the scope of the present disclosure includes more than five projectors 22 positioned in probe 28 and more than seven cameras positioned in probe 28.

In an example application, an apparatus for intraoral scanning (e.g., an intraoral scanner) includes an elongate wand comprising a probe at a distal end of the elongate wand, at least two light projectors disposed within the probe, and at least four cameras disposed within the probe. Each light projector may include at least one light source configured to generate light when activated, and a pattern generating optical element that is configured to generate a pattern of light when the light is transmitted through the pattern generating optical element. Each of the at least four cameras may include a camera sensor and one or more lenses, wherein each of the at least four cameras is configured to capture a plurality of images that depict at least a portion of the projected pattern of light on an intraoral surface. In one embodiment, a majority of the at least two light projectors and the at least four cameras may be arranged in at least two rows that are each approximately parallel to a longitudinal axis of the probe, the at least two rows comprising at least a first row and a second row.

In a further application, a distal-most camera along the longitudinal axis and a proximal-most camera along the longitudinal axis of the at least four cameras are positioned such that their optical axes are at an angle of 90 degrees or less with respect to each other from a line of sight that is perpendicular to the longitudinal axis. Cameras in the first row and cameras in the second row may be positioned such that optical axes of the cameras in the first row are at an angle of 90 degrees or less with respect to optical axes of the cameras in the second row from a line of sight that is coaxial with the longitudinal axis of the probe. A remainder of the at least four cameras other than the distal-most camera and the proximal-most camera have optical axes that are substantially parallel to the longitudinal axis of the probe. Each of the at least two rows may include an alternating sequence of light projectors and cameras.

In a further application, the at least four cameras comprise at least five cameras, the at least two light projectors comprise at least five light projectors, a proximal-most component in the first row is a light projector, and a proximal-most component in the second row is a camera.

In a further application, the distal-most camera along the longitudinal axis and the proximal-most camera along the longitudinal axis are positioned such that their optical axes are at an angle of 35 degrees or less with respect to each other from the line of sight that is perpendicular to the longitudinal axis. The cameras in the first row and the cameras in the second row may be positioned such that the optical axes of the cameras in the first row are at an angle of 35 degrees or less with respect to the optical axes of the cameras in the second row from the line of sight that is coaxial with the longitudinal axis of the probe.

In a further application, the at least four cameras may have a combined field of view of about 25-45 mm or about 20-50 mm along the longitudinal axis and a field of view of about 20-40 mm or about 15-80 mm along a z-axis corresponding to distance from the probe. Other FOVs discussed herein may also be provided.

In the examples shown in FIGS. 5-6, cameras and structured light projectors directly face an object that is scanned. However, in other embodiments one or more structured light projectors and/or cameras may face a mirror, which may redirect light rays and returning light rays towards and/or from an object being scanned. In some embodiments, structured light projectors and cameras are arranged into one or more scan units, which may be arranged along the longitudinal axis of the probe. A scan unit may be understood herein as a unit comprising at least light projector and one or more cameras. In some embodiments, each scan unit comprises at least two cameras having at least partly overlapping fields of view along different camera optical axes. In one embodiment, each scan unit comprises at least four cameras having at least partly overlapping fields of view along different camera optical axes. An advantage of having overlapping fields of view of the cameras is an improved accuracy due to a reduced amount of image stitching errors. A further advantage of utilizing multiple cameras, such as two or more cameras, is that the reliability of the determination of 3D points is improved, whereby the accuracy of the generated digital 3D representation is improved. A scan unit may further comprise one or more lenses such as collimation lenses or projection lenses.

In some embodiments, one or more scan units may face an object being scanned and/or one or more scan units may face a mirror. Scan units that face an object being scanned may be referred to as downward looking scan units, and may have an imaging axis that is at an angle (e.g., perpendicular) to a longitudinal axis of a probe. Scan units that face a mirror may be referred to as forward looking scan units, and may have an imaging axis that is approximately parallel to a longitudinal axis of a probe. In some embodiments, all scan units are downward looking. In some embodiments, all scan units are forward looking. In some embodiments, some scan units are downward looking and some scan units are forward looking. In some embodiments, scan units are used as set forth in U.S. Patent Application No. 63/656,524, filed Jun. 5, 2024, which is incorporated by reference herein in its entirety.

In some embodiments, the intraoral scanner comprises a plurality of scan units positioned along the longitudinal axis of the intraoral scanner. For example, two scan units may be positioned in series along the longitudinal axis of the intraoral scanner. A scan unit may have a predefined field of view (FOV) and/or a predefined angular field of view (AFOV). In some embodiments, the FOV of each scan unit is at least 300 mm², preferably at least 400 mm², preferably at least 500 mm², preferably at least 550 mm², wherein the area is measured for a given predefined focus distance or working distance. As an example, the field of view of the intraoral scanner may be at least 20×20 mm², such as at least 23×23 mm², at a working distance of between 18 mm to 36 mm, such as approximately 20 mm to 24 mm. For some applications, e.g. for dental scanning applications, the intraoral scanner has a working distance of between 10 mm and 100 mm. In some embodiments, a working distance of the projector unit of between 10 mm and 70 mm, such as between 15 mm and 50 mm, is used. Since the scan unit(s) then take up less space inside the intraoral scanner, it also allows for multiple scan units to be placed in succession inside the intraoral scanner. In some embodiments, the intraoral scanner is able to project a pattern in focus at the exit of the tip of the intraoral scanner, e.g. at the optical window of the s intraoral scanner or at an opening in the surface of the intraoral scanner. The working distance may be understood as the object to lens distance where the image is at its sharpest focus. The working distance may also, or alternatively, be understood as the distance from the object to a front lens, e.g. a front lens of the projector unit. The front lens may be the one or more focus lenses of the projector unit.

In some embodiments the elongated probe comprises one or more openings and/or one or more optical windows at a distal end of the elongated probe. In some embodiments, there is an opening and/or an optical window in the elongated probe, wherein the opening/window is associated with each scan unit, such that each scan unit is configured to project the light pattern through said opening or optical window. Accordingly, the elongated probe may comprise an opening and/or an optical window for each scan unit of the intraoral scanner. The optical window may be made in a polymer material such as poly(methyl methacrylate) (PM MA) or in a ceramic or glass material such as Sapphire glass. The optical window may be made in a transparent, crystalline, ceramic material, such as aluminum oxide (Al₂O₃). Alternatively, the optical window may be made of a mineral glass. In some embodiments, the predefined distance mentioned in relation to the FOV of a given scan unit is measured below said opening/window. In some embodiments, the FOV of at least one scan unit is at least 500 mm², such as approximately 23×23 mm², in a distance approximately 0-15 mm, such as 4-7 mm below said opening/window. This may correspond to a working distance of between 15 mm and 50 mm, such as between 15 mm and 36 mm.

The angular field of view (AFOV) of a scan unit may be correlated to the FOV. In accordance with some embodiments, each scan unit defines an angular field of view (AFOV) of between 50° to 80°, such as between 60° to 75°. In accordance with some embodiments, the projector optical axis and the camera optical axis of at least one camera define a camera-projector angle of approximately 5 to 25 degrees, or 5 to 15 degrees, or 5 to 10 degrees, or 8 to 10 degrees. In some embodiments, the scan unit(s) are rotationally symmetric, such that each camera optical axis defines an approximately similar camera-projector angle with the projector unit of the scan unit.

In embodiments, wherein the intraoral scanner comprises at least two scan units, the intraoral scanner has a FOV, which is larger than the FOV of each scan unit. As an example, if the intraoral scanner comprises two scan units, each scan unit having a predefined FOV, then the intraoral scanner will have twice as large a FOV as each scan unit, provided there is no overlap in FOV between the scan units. In some cases, there may be a small overlap in FOV, but in general the intraoral scanner will have a larger field of view, or in other words an extended field of view, compared to one scan unit in isolation. Accordingly, the FOV of the intraoral scanner can be increased/scaled by the number of scan units in the intraoral scanner. In some embodiments, the intraoral scanner comprises at least three scan units. Accordingly, the intraoral scanner may further comprise a third scan unit comprising a third projector unit, said projector unit preferably configured to project the light pattern at a predefined third focus distance. A scan unit may further comprise at least one reflecting element, such as a mirror or a prism, wherein said reflecting element is configured to alter the direction of the light projected by the projector unit of the scan unit. In general, a scan unit can be oriented in many different ways, wherein the orientation is defined according to the projector optical axis of the scan unit. As an example, a scan unit may be oriented such that the projector optical axis of the scan unit is substantially parallel with the longitudinal axis of the intraoral scanner. Additionally, a scan unit may be oriented such that the light from the projector unit is projected in a forward direction, i.e. towards the distal end of the intraoral scanner. In case, a scan unit is oriented in this way, the scan unit is also referred to as being in a forward-looking configuration. In some embodiments, each scan unit comprises a reflecting element. In other embodiments, at least one scan unit comprises a reflecting element.

As another example, a scan unit may be oriented such that the projector optical axis of the scan unit is angled with respect to the longitudinal axis of the intraoral scanner or with respect to a projector optical axis of another scan unit. In some embodiments, at least one of the projector optical axes is substantially orthogonal to the longitudinal axis of the intraoral scanner. Additionally, such a scan unit may be oriented such that the light from the projector unit is projected in a downward direction, i.e. directly towards the dental object to be scanned. In case a scan unit is oriented in this way, the scan unit is also referred to as being in a downward-looking configuration. If the intraoral scanner comprises a plurality of scan units, such as at least two scan units, the scan units may be in different configurations, e.g. a first scan unit in the forward-looking configuration and a second scan unit in the downward-looking configuration. In this embodiment, the first projector optical axis is substantially parallel to the longitudinal axis of the intraoral scanner, and the second projector optical axis is substantially orthogonal to the longitudinal axis of the intraoral scanner. In other words, a first projector optical axis of a first projector unit of the first scan unit is angled with respect to a second projector optical axis of a second projector unit of the second scan unit. This angle may be at least 45°, such as at least 75°, or at least 85°, or approximately 90°.

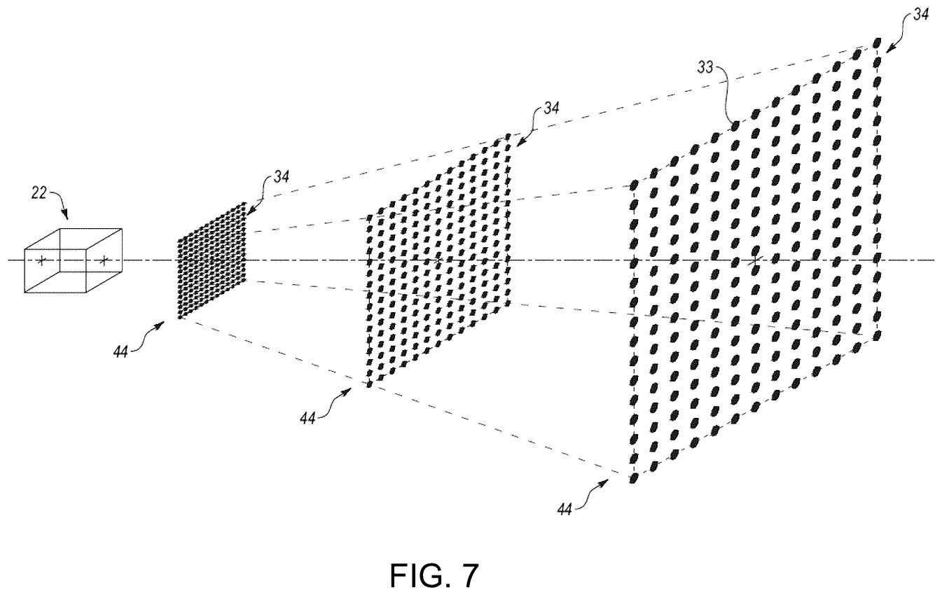

Reference is now made to FIG. 7, which is a schematic illustration of a structured light projector 22 projecting a distribution of discrete unconnected spots of light onto a plurality of object focal planes, in accordance with some applications of the present disclosure. FIGS. 7-19 are described with reference to a light pattern that comprises spots. However, the described solution to the correspondence problem works equally well for other light patterns (e.g., such as a checkerboard pattern). In embodiments, the light pattern may be patterned visible light and/or patterned infrared light. For example, in some embodiments some of the spots correspond to visible light rays and some of the spots may correspond to infrared light rays. 3D surface 32A, 32B being scanned may be one or more teeth or other intraoral object/tissue inside a subject's mouth. The somewhat translucent and glossy properties of teeth may affect the contrast of the structured light pattern being projected. For example, (a) some of the light hitting the teeth may scatter to other regions within the intraoral scene, causing an amount of stray light, and (b) some of the light may penetrate the tooth and subsequently come out of the tooth at any other point. Thus, in order to improve image capture of an intraoral scene under structured light illumination, without using contrast enhancement means such as coating the teeth with an opaque powder, a sparse distribution 34 of discrete unconnected spots of light may provide an improved balance between reducing the amount of projected light while maintaining a useful amount of information. The sparseness of distribution 34 may be characterized by a ratio of: (a) illuminated area on an orthogonal plane 44 in field of illumination α (alpha), i.e., the sum of the area of all projected spots 33 on the orthogonal plane 44 in field of illumination α (alpha), to (b) non-illuminated area on orthogonal plane 44 in field of illumination α (alpha). In some applications, sparseness ratio may be at least 1:150 and/or less than 1:16 (e.g., at least 1:64 and/or less than 1:36).

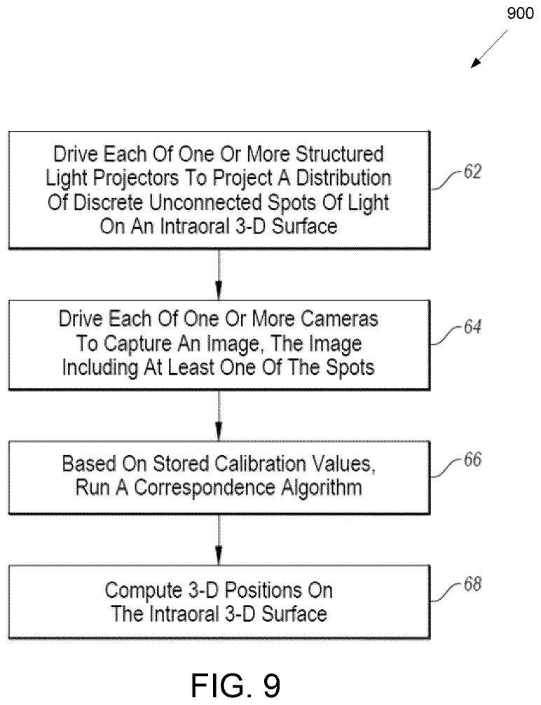

In some applications, one or more structured light projector 22 projects at least 400 discrete unconnected spots 33 onto an intraoral three-dimensional surface during a scan. In some applications, one or more structured light projector 22 projects less than 3000 discrete unconnected spots 33 onto an intraoral surface during a scan. In the case of a sparse distribution of infrared light rays (e.g., a corresponding infrared spots), in some applications one or more structured light projector projects 3-9 discrete unconnected spots of infrared light. In order to reconstruct the three-dimensional surface from projected sparse distribution 34, correspondence between respective projected spots 33 and the spots detected by cameras 24 is determined, as further described hereinbelow with reference to FIGS. 9-19. The discussion of FIGS. 9-19 applies to both patterned visible light and patterned infrared light. However, for patterned infrared light a single projector ray may correspond to multiple camera rays (e.g., there may be multiple intersections associated with a single projector ray, which may show up as a line in an image captured by a camera).

Reference is now made to FIGS. 8A-B, which are schematic illustrations of a structured light projector 22 projecting discrete unconnected spots 33 and a camera sensor 58 detecting spots 33′, in accordance with some applications of the present disclosure. For some applications, a method is provided for determining correspondence between the projected spots 33 on the intraoral surface and detected spots 33′ on respective camera sensors 58. Once the correspondence is determined, a three-dimensional image of the surface of a tooth and/or of an internal structure inside a tooth is reconstructed. Each camera sensor 58 has an array of pixels, for each of which there exists a corresponding camera ray 86. Similarly, for each projected spot 33 from each projector 22 there exists a corresponding projector ray 88. Each projector ray 88 corresponds to a respective path 92 of pixels on at least one of camera sensors 58. Thus, if a camera sees a spot 33′ projected by a specific projector ray 88, that spot 33′ will necessarily be detected by a pixel on the specific path 92 of pixels that corresponds to that specific projector ray 88. With specific reference to FIG. 8B, the correspondence between respective projector rays 88 and respective camera sensor paths 92 is shown. Projector ray 88′ corresponds to camera sensor path 92′, projector ray 88″ corresponds to camera sensor path 92″, and projector ray 88″ corresponds to camera sensor path 92″. For example, if a specific projector ray 88 were to project a spot of infrared light into a tooth, a line in the tooth enamel would be illuminated. The line in the tooth enamel as detected by camera sensor 58 would follow the same path on camera sensor 58 as the camera sensor path 92 that corresponds to the specific projector ray 88, as altered by phenomena such as angle of intercept of a projector ray with a tooth surface, index of refraction of the tooth, interface with a crack within a tooth, and so on.

During a calibration process, calibration values are stored based on camera rays 86 corresponding to pixels on camera sensor 58 of each one of cameras 24, and projector rays 88 corresponding to projected spots 33 of light from each structured light projector 22. For example, calibration values may be stored for (a) a plurality of camera rays 86 corresponding to a respective plurality of pixels on camera sensor 58 of each one of cameras 24, and (b) a plurality of projector rays 88 corresponding to a respective plurality of projected spots 33 of light from each structured light projector 22.

By way of example, the following calibration process may be used. A high accuracy dot target, e.g., black dots on a white background, is illuminated from below and an image is taken of the target with all the cameras. The dot target is then moved perpendicularly toward the cameras, i.e., along the z-axis, to a target plane. The dot-centers are calculated for all the dots in all respective z-axis positions to create a three-dimensional grid of dots in space. A distortion and camera pinhole model is then used to find the pixel coordinate for each three-dimensional position of a respective dot-center, and thus a camera ray is defined for each pixel as a ray originating from the pixel whose direction is towards a corresponding dot-center in the three-dimensional grid. The camera rays corresponding to pixels in between the grid points can be interpolated. The above-described camera calibration procedure is repeated for all respective wavelengths of respective laser diodes 36, such that included in the stored calibration values are camera rays 86 corresponding to each pixel on each camera sensor 58 for each of the wavelengths.

After cameras 24 have been calibrated and all camera ray 86 values stored, structured light projectors 22 may be calibrated as follows. A flat featureless target is used and structured light projectors 22 are turned on one at a time. Each spot is located on at least one camera sensor 58. Since cameras 24 are now calibrated, the three-dimensional spot location of each spot is computed by triangulation based on images of the spot in multiple different cameras. The above-described process is repeated with the featureless target located at multiple different z-axis positions. Each projected spot on the featureless target will define a projector ray in space originating from the projector.

Reference is now made to FIG. 9, which is a flow chart outlining a method 900 for determining depth values of points in an intraoral scan, in accordance with some applications of the present disclosure. Method 900 may be implemented, for example, at block 110 and 120 of method 101.

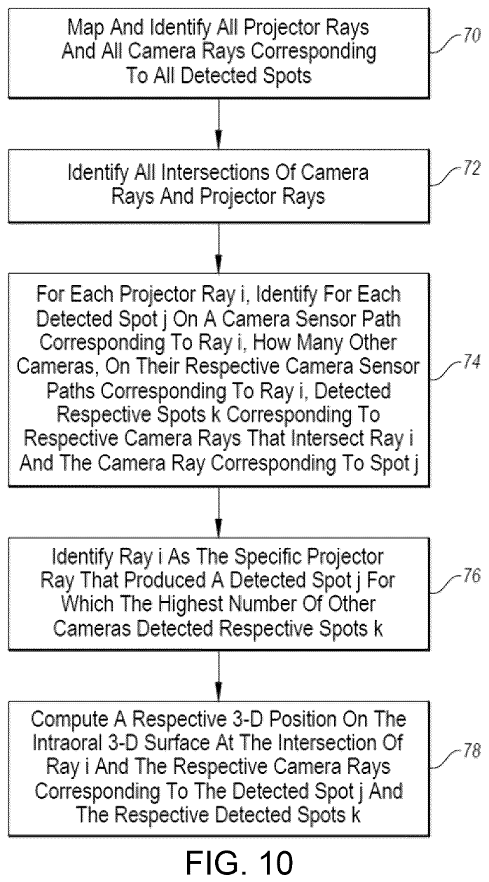

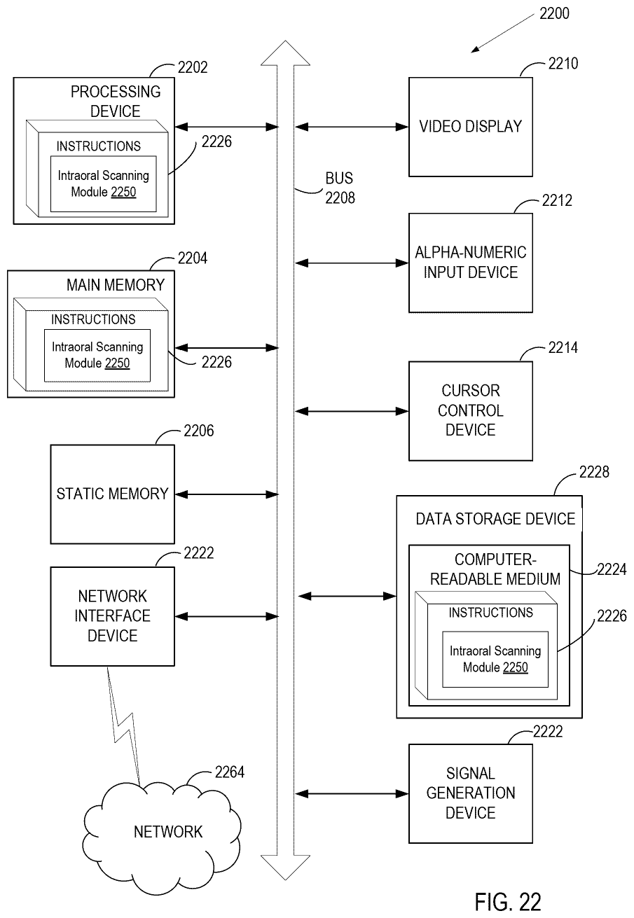

In operations 62 and 64, respectively, of method 900, each structured light projector 22 is driven to project distribution 34 of discrete unconnected spots 33 of light on an intraoral three-dimensional surface, and each camera 24 is driven to capture an image that includes at least one of spots 33. Based on the stored calibration values indicating (a) a camera ray 86 corresponding to each pixel on camera sensor 58 of each camera 24, and (b) a projector ray 88 corresponding to each projected spot 33 of light from each structured light projector 22, a correspondence algorithm is run in operation 66 using a processor 96, further described hereinbelow with reference to FIGS. 10-14. Processor 96 may be a processor of computing device 305 of FIG. 3 in embodiments, and may correspond to processing device 2220 of FIG. 22 in embodiments. Once the correspondence is solved, three-dimensional positions on the intraoral surface and/or of internal structures within teeth may be computed in operation 68 and used to generate a digital three-dimensional image of the intraoral surface and/or of the internal structures within teeth. Furthermore, capturing the intraoral scene using multiple cameras 24 provides a signal to noise improvement in the capture by a factor of the square root of the number of cameras.

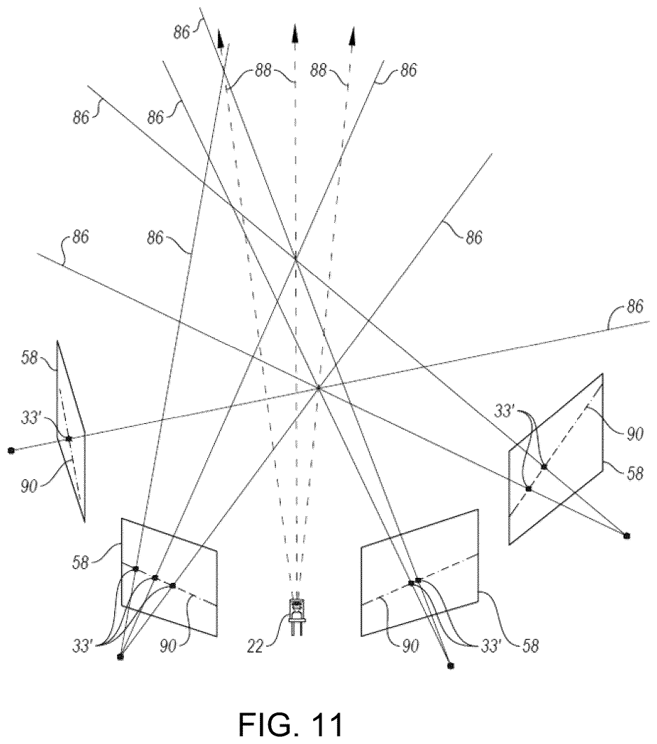

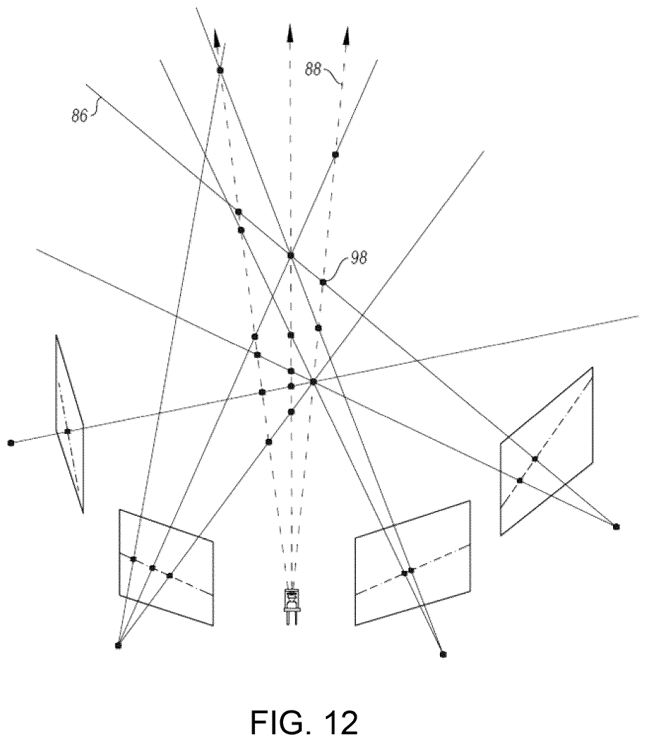

Reference is now made to FIG. 10, which is a flowchart outlining the correspondence algorithm of operation 66 in method 900, in accordance with some applications of the present disclosure. Based on the stored calibration values, all projector rays 88 and all camera rays 86 corresponding to all detected spots 33′ are mapped (operation 70), and all intersections 98 (FIG. 12) of at least one camera ray 86 and at least one projector ray 88 are identified (operation 72). FIGS. 11 and 12 are schematic illustrations of a simplified example of operations 70 and 72 of FIG. 10, respectively. As shown in FIG. 11, three projector rays 88 are mapped along with eight camera rays 86 corresponding to a total of eight detected spots 33′ on camera sensors 58 of cameras 24. As shown in FIG. 12, sixteen intersections 98 are identified.

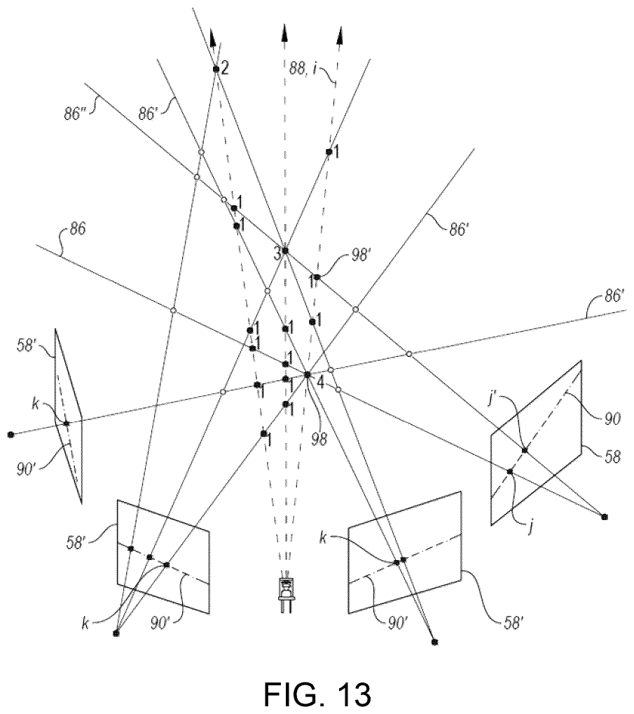

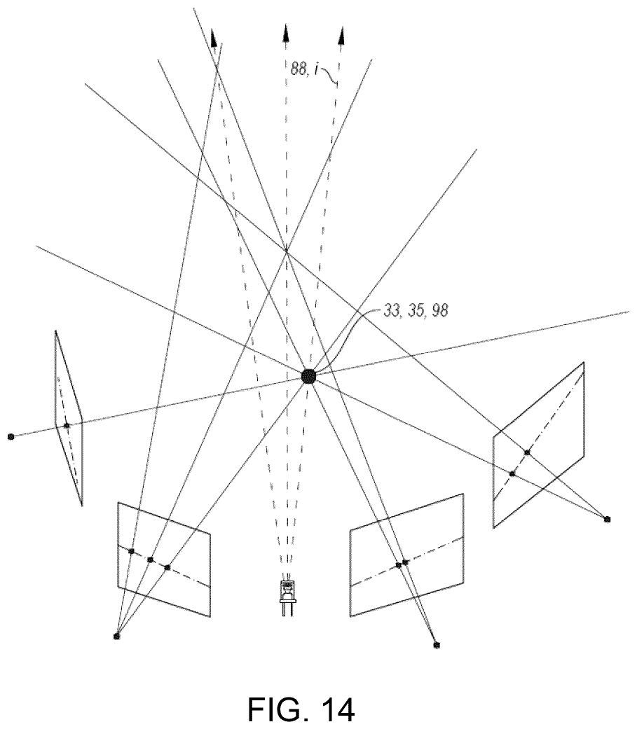

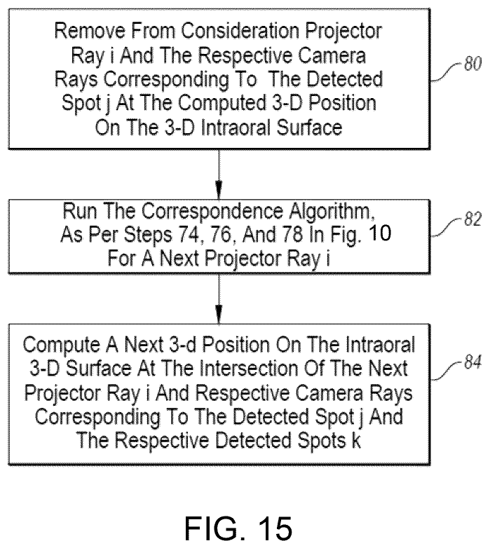

In operations 74 and 76 of method 900, processor 96 determines a correspondence between projected spots 33 and detected spots 33′ so as to identify a three-dimensional location for each projected spot 33 on the surface. FIG. 13 is a schematic illustration depicting operations 74 and 76 of FIG. 10 using the simplified example described hereinabove in the immediately preceding paragraph. For a given projector ray i, processor 96 “looks” at the corresponding camera sensor path 90 on camera sensor 58 of one of cameras 24. Each detected spot j along camera sensor path 90 will have a camera ray 86 that intersects given projector ray i, at an intersection 98. Intersection 98 defines a three-dimensional point in space. Processor 96 then “looks” at camera sensor paths 90′ that correspond to given projector ray i on respective camera sensors 58′ of other cameras 24, and identifies how many other cameras 24, on their respective camera sensor paths 90′ corresponding to given projector ray i, also detected respective spots k whose camera rays 86′ intersect with that same three-dimensional point in space defined by intersection 98. The process is repeated for all detected spots j along camera sensor path 90, and the spot j for which the highest number of cameras 24 “agree,” is identified as the spot 33 (FIG. 14) that is being projected onto the surface from given projector ray i. That is, projector ray i is identified as the specific projector ray 88 that produced a detected spot j for which the highest number of other cameras detected respective spots k. A three-dimensional position on the surface is thus computed for that spot 33.

For example, as shown in FIG. 13, all four of the cameras detect respective spots, on their respective camera sensor paths corresponding to projector ray i, whose respective camera rays intersect projector ray i at intersection 98, intersection 98 being defined as the intersection of camera ray 86 corresponding to detected spot j and projector ray i. Hence, all four cameras are said to “agree” on there being a spot 33 projected by projector ray i at intersection 98. When the process is repeated for a next spot j′, however, none of the other cameras detect respective spots, on their respective camera sensor paths corresponding to projector ray i, whose respective camera rays intersect projector ray i at intersection 98′, intersection 98′ being defined as the intersection of camera ray 86″ (corresponding to detected spot j′) and projector ray i. Thus, only one camera is said to “agree” on there being a spot 33 projected by projector ray i at intersection 98′, while four cameras “agree” on there being a spot 33 projected by projector ray i at intersection 98. Projector ray i is therefore identified as being the specific projector ray 88 that produced detected spot j, by projecting a spot 33 onto the surface at intersection 98 (FIG. 14). As per operation 78 of FIG. 10, and as shown in FIG. 14, a three-dimensional position 35 on the intraoral surface is computed at intersection 98.

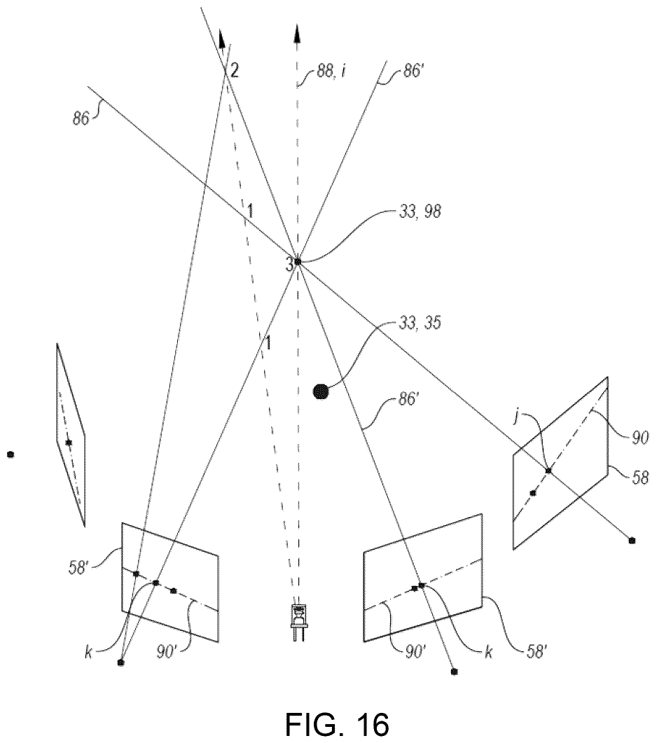

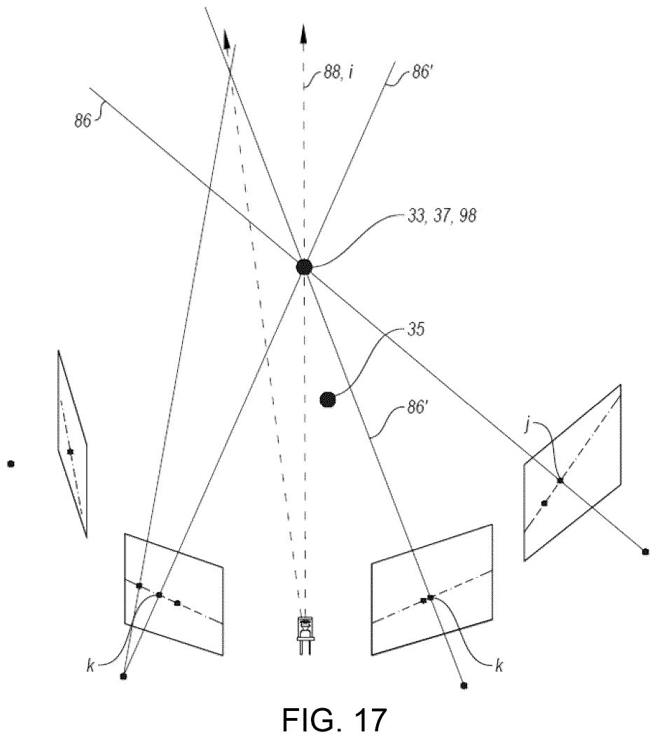

Reference is now made to FIG. 15, which is a flow chart outlining further operations in the correspondence algorithm, in accordance with some applications of the present disclosure. Once position 35 on the surface is determined, projector ray i that projected spot j, as well as all camera rays 86 and 86′ corresponding to spot j and respective spots k may be removed from consideration (operation 80) and the correspondence algorithm may be run again for a next projector ray i (operation 82). In the case of projected infrared spots or other pattern features, in some cases the projector rays may not be removed from consideration after an intersection with a camera ray is identified, because the projector rays may have intersections with multiple camera rays as the associated infrared light rays travel through the enamel of a tooth. FIG. 16 depicts the simplified example described hereinabove after the removal of the specific projector ray i that projected spot 33 at position 35. As per operation 82 in the flow chart of FIG. 15, the correspondence algorithm may then run again for a next projector ray i. As shown in FIG. 16, the remaining data show that three of the cameras “agree” on there being a spot 33 at intersection 98, intersection 98 being defined by the intersection of camera ray 86 corresponding to detected spot j and projector ray i. Thus, as shown in FIG. 17, a three-dimensional position 37 is computed at intersection 98.

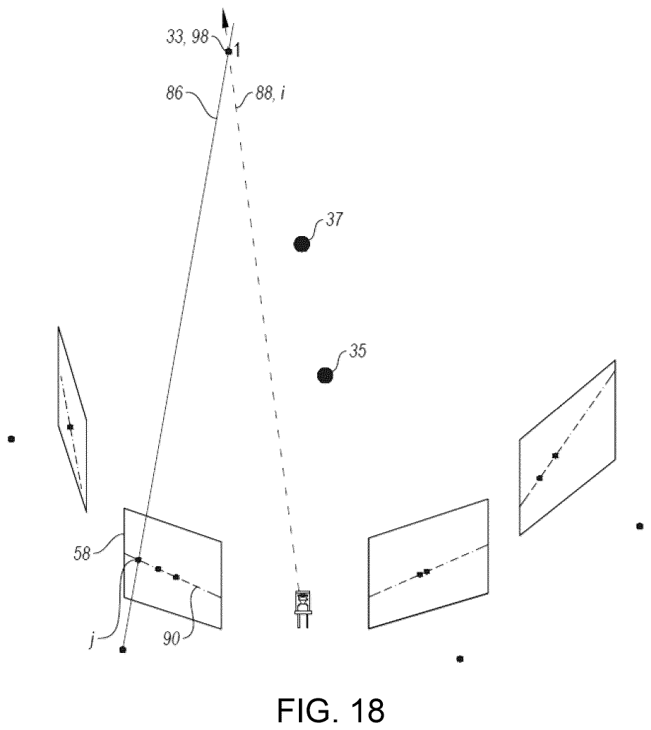

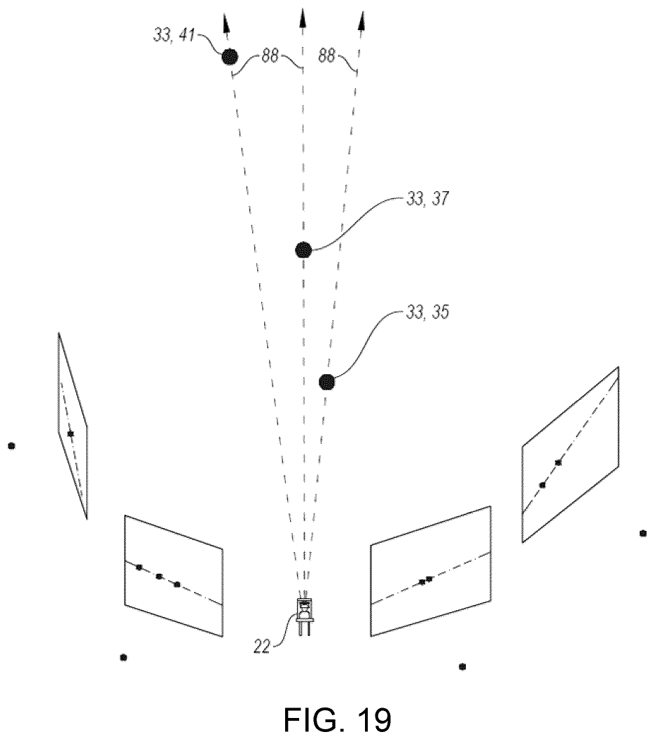

As shown in FIG. 18, once three-dimensional position 37 on the surface is determined, again projector ray i that projected spot j, as well as all camera rays 86 and 86′ corresponding to spot j and respective spots k are removed from consideration. In the case of infrared light rays, the projector ray may not be removed from consideration in some embodiments. The remaining data show a spot 33 projected by projector ray i at intersection 98, and a three-dimensional position 41 on the surface is computed at intersection 98. As shown in FIG. 19, according to the simplified example, the three projected spots 33 of the three projector rays 88 of structured light projector 22 have now been located on the surface at three-dimensional positions 35, 37, and 41. In some applications, each structured light projector 22 projects 400-3000 spots 33. Once correspondence is solved for all projector rays 88, a reconstruction algorithm may be used to reconstruct a digital image of the surface using the computed three-dimensional positions of the projected spots 33.

Reference is again made to FIG. 5. For some applications, there is at least one non-structured light projector 118 coupled to rigid structure 26. Non-structured light projector 118 transmits white light onto 3D surface 32, 33 being scanned. At least one camera, e.g., one of cameras 24, captures two-dimensional color images of 3D surface 32A using illumination from non-structured light projector 118. Processor 96 may run a surface reconstruction algorithm that combines at least one image captured using illumination from structured light projectors 22 with a plurality of images captured using illumination from non-structured light projector 118 in order to generate a digital three-dimensional image of the intraoral three-dimensional surface. Using a combination of structured light and non-structured (e.g., smooth) illumination enhances the overall capture of the intraoral scanner and may help reduce the number of options that processor 96 needs to consider when running the correspondence algorithm.

Reference is now made to FIGS. 20A-B, which are schematic illustrations of one example structured light projector 22 with more than one light source 2036A-B (e.g., laser diodes), in accordance with some applications of the present invention. In embodiments, light source 2036A projects visible coherent light (e.g., in the red or green or blue wavelengths) and light source 2036B projects infrared coherent light. In embodiments, a beam splitter 2062 may combine light output by light source 2036A and by light source 2036B.

In some embodiments, beam splitter 2062 may be a standard 50/50 splitter, lowering the efficiency of both beams to under 50%, or a polarizing beam splitter (PBS), keeping the efficiency at greater than 90%. For some applications, each light source 2036A-B may have its own collimating lens 2030, such as is shown in FIG. 20A. Alternatively, the plurality of light sources 2036A-B may share a collimating lens 2030, the collimating lens being disposed between beam splitter 2062 and a pattern generating optical element 2038, such as is shown in FIG. 20B. Pattern generating optical element 2038 may be diffractive optical element (DOE), segmented DOE, micro-lens array, or compound diffractive periodic structure in embodiments.

As described hereinabove, a sparse distribution of projected pattern features improves capture by providing an improved balance between reducing the amount of projected light while maintaining a useful amount of information. The number of projected infrared pattern features may be less than the number of projected visible pattern features in embodiments. For some applications, in order to provide a higher density pattern without reducing capture, a plurality of visible light sources having different wavelengths in the visible spectrum may be combined with the light source that emits infrared light. For example, each structured light projector 22 may include at least at least three laser diodes that transmit light at distinct respective wavelengths, where one of the wavelengths is in the infrared spectrum (or near-infrared spectrum). Although projected spots may be nearly overlapping in some cases, the different wavelength spots may be resolved in space using the camera sensors' color distinguishing capabilities (e.g., of an RGBIR filter) and/or image processing performed by a processing device. Optionally, red, blue, green and/or IR laser diodes may be used. All of the structured light projector configurations described hereinabove may be implemented using a plurality of laser diodes in each structured light projector in some embodiments.

Reference is now made to FIGS. 21A-B, which are schematic illustrations of different ways to combine light sources of different wavelengths, in accordance with some applications of the present invention. Combining two or more lasers of different wavelengths into the same diffractive element can be done using a fiber coupler 2064 as shown in FIG. 21A or a laser combiner 2066 as shown in FIG. 21B. For laser combiner 2066 the combining element may be a dichroic two-way or three-way dichroic combiner. Within each structured light projector 22 all laser diodes may transmit light through a common pattern generating optical element 2038, either simultaneously or at different times. The respective laser beams may hit slightly different positions in pattern generating optical element 2038 and create different patterns. These patterns will not interfere with each other due to different wavelengths, different times of pulse, and/or different angles. Using fiber coupler 2064 or laser combiner 2066 allows for light sources 2036A-B to be disposed in a remote enclosure 2068 in some embodiments. Remote enclosure 2068 may be disposed in a proximal region of handheld wand 20, thus allowing for a smaller probe in some embodiments.

FIG. 22 illustrates a diagrammatic representation of a machine in the example form of a computing device 2200 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 2200 includes a processing device 2202, a main memory 2204 (e.g., read-only memory (ROM), flash memory, dynamic random access memory (DRAM) such as synchronous DRAM (SDRAM), etc.), a static memory 2206 (e.g., flash memory, static random access memory (SRAM), etc.), and a secondary memory (e.g., a data storage device 2228), which communicate with each other via a bus 2208.

Processing device 2202 represents one or more general-purpose processors such as a microprocessor, central processing unit, or the like. More particularly, the processing device 2202 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 2202 may also be one or more special-purpose processing devices such as an application specific integrated circuit (ASIC), a field programmable gate array (FPGA), a digital signal processor (DSP), network processor, or the like. Processing device 2202 is configured to execute the processing logic (instructions 2226) for performing operations and operations discussed herein.

The computing device 2200 may further include a network interface device 2222 for communicating with a network 2264. The computing device 2200 also may include a video display unit 2210 (e.g., a liquid crystal display (LCD) or a cathode ray tube (CRT)), an alphanumeric input device 2212 (e.g., a keyboard), a cursor control device 2214 (e.g., a mouse), and a signal generation device 2220 (e.g., a speaker).

The data storage device 2228 may include a machine-readable storage medium (or more specifically a non-transitory computer-readable storage medium) 2224 on which is stored one or more sets of instructions 2226 embodying any one or more of the methodologies or functions described herein. Wherein a non-transitory storage medium refers to a storage medium other than a carrier wave. The instructions 2226 may also reside, completely or at least partially, within the main memory 2204 and/or within the processing device 2202 during execution thereof by the computer device 2200, the main memory 2204 and the processing device 2202 also constituting computer-readable storage media.

The computer-readable storage medium 2224 may also be used to store an intraoral scanning module 2250, which may correspond to similarly named components of FIG. 4. The computer readable storage medium 2224 may also store a software library containing methods that call an intraoral scanning module 2250, a surface detection module, an internal tooth structure detection module and/or a model generation module. While the computer-readable storage medium 2224 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. An intraoral scanning system, comprising:
an intraoral scanner comprising:
one or more infrared structured light projectors configured to project patterned infrared light onto a tooth; and
one or more cameras configured to generate one or more images of the patterned infrared light projected onto the tooth; and
a computing device configured to determine one or more internal properties of the tooth based on processing of the one or more images.

2. The intraoral scanning system of claim 1, wherein the patterned infrared light comprises a plurality of infrared light rays, and wherein the computing device is further configured to:
identify, in the one or more images, a surface reflection of the plurality of infrared light rays with a surface of the tooth; and
identify, in the one or more images, scattering of the plurality of infrared light rays associated with an internal structure of the tooth;
wherein the one or more internal properties of the tooth are determined based on at least one of the surface reflection or the scattering.

3. The intraoral scanning system of claim 2, wherein the computing device is further configured to:
estimate a depth of the internal structure based on determining a distance between the surface of the tooth determined from the surface reflection and a surface of the internal structure determined from the scattering.

4. The intraoral scanning system of claim 2, wherein the computing device is further configured to:
use a correspondence algorithm to determine three-dimensional coordinates of the surface of the tooth and of the internal structure of the tooth based on identifying, for one or more infrared light rays of the plurality of infrared light rays, correspondence to points captured in the one or more images.

5. The intraoral scanning system of claim 4, wherein the computing device is further configured to:
solve the correspondence algorithm using the one or more images to determine the one or more internal properties of the tooth, wherein the correspondence algorithm is adjusted for points inside the tooth based on at least one of the surface of the tooth or an estimated index of refraction of an enamel of the tooth.

6. The intraoral scanning system of claim 2, wherein the computing device is further configured to:
process the one or more images using a trained machine learning model, wherein the trained machine learning model outputs, for each infrared light ray of the plurality of infrared light rays captured in the one or more images, an estimated coordinate of an intersection of the infrared light ray with the internal structure and a class of the internal structure.

7. The intraoral scanning system of claim 2, wherein the internal structure comprises a caries, and wherein the one or more internal properties of the tooth comprise at least one of a shape, a volume, a position, or a depth of the caries.

8. The intraoral scanning system of claim 2, wherein the internal structure comprises dentin of the tooth, and wherein the one or more internal properties of the tooth comprise at least one of a shape, a volume, a position, or a depth of the dentin.

9. The intraoral scanning system of claim 2, wherein the computing device is further configured to:
identify, in the one or more images, an abrupt change in direction of one or more infrared light rays of the plurality of infrared light rays after a surface of the tooth determined from the surface reflection; and
identify a crack in the tooth based on the abrupt change in direction of the one or more infrared light rays.

10. The intraoral scanning system of claim 2, wherein the computing device is further configured to:
identify, in the one or more images, an angle change of at least one of the plurality of infrared light rays after the surface reflection; and
determine one or more additional properties of the tooth based at least in part on the angle change.

11. The intraoral scanning system of claim 2, wherein the computing device is further configured to:
process the one or more images using a trained machine learning model, wherein the trained machine learning model outputs ray tracking information for the plurality of infrared light rays in the one or more images.

12. The intraoral scanning system of claim 2, wherein the intraoral scanner further comprises:
one or more visible structured light projectors configured to project patterned visible light comprising a plurality of visible light rays onto the tooth;
wherein the one or more cameras are further configured to generate one or more additional images of the patterned visible light projected onto the tooth by the one or more cameras of the intraoral scanner; and
the computing device is further configured to solve a correspondence algorithm using the one or more additional images to determine a three-dimensional surface of the tooth.

13. The intraoral scanning system of claim 12, wherein at least one of:
the patterned visible light and the patterned infrared light have a same unchanging pattern; or
a same diffractive optical element or a same microlens array is used to generate both the patterned infrared light and the patterned visible light.

14. The intraoral scanning system of claim 2, wherein the internal structure of the tooth comprises at least one of a dentin of the tooth or a caries of the tooth, and wherein the computing device is further configured to:
distinguish between the dentin and the caries based on behavior of the plurality of infrared light rays interacting with the internal structure and a determined shape of the internal structure.

15. The intraoral scanning system of claim 1, wherein the one or more structured light projectors comprise:
one or more lasers configured to generate a plurality of infrared light rays; and
one or more collimating lenses configured to collimate the plurality of infrared light rays.

16. The intraoral scanning system of claim 1, wherein the one or more structured light projectors comprise:
a laser configured to generate infrared light; and
at least one of a diffractive optical element or a microlens array configured to generate a plurality of infrared light rays from the infrared light.

17. The intraoral scanning system of claim 1, wherein the patterned infrared light comprises less than 25 light rays.

18. The intraoral scanning system of claim 1, wherein the one or more infrared structured light projectors are configured to output polarized patterned infrared light, the intraoral scanning system further comprising:
a polarization filter to polarize light reaching the one or more cameras.

19. An intraoral scanning system, comprising:
an intraoral scanner comprising:
an elongate wand comprising a probe at a distal end of the elongate wand;
one or more visible structured light projectors disposed in the probe and configured to project patterned visible light onto a tooth;
one or more infrared structured light projectors disposed in the probe and configured to project patterned infrared light onto the tooth;
two or more cameras disposed in the probe and configured to generate two or more visible light images of the patterned visible light projected onto the tooth and to generate two or more infrared images of the patterned infrared light projected onto the tooth; and
one or more processors configured to:
solve a correspondence algorithm using the one or more visible light images to determine a three-dimensional surface of the tooth; and
process the one or more infrared images to determine one or more internal properties of the tooth.

20. The intraoral scanning system of claim 19, wherein the one or more infrared structured light projectors each has a respective first orientation, wherein the one or more cameras each has a respective second orientation, and wherein the respective second orientation of each of the one or more cameras has an angle of 5-25 degrees relative to the respective first orientation of the one or more infrared structured light projectors.
